(19) United States
(12) Patent Application Publication
(10) Pub. No.: US 2010/0102910 A1
(43) Pub. Date: Apr. 29, 2010

(54) AUSTENITIC IRON-NICKEL-CHROMIUM-COPPER ALLOY

(75) Inventors: Thierry Waeckerle, Nevers (FR); Olena Danylova, Nevers (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Arcelormittal-Stainless & Nickel Alloys, Saint-Denis (FR)

(21) Appl. No.: 12/593,726

(22) PCT Filed: Mar. 26, 2008
(86) PCT No.: PCT/FR08/00403

§ 371 Date: Dec. 17, 2009

(30) Foreign Application Priority Data
Mar. 30, 2007 (EP) 07290382.6

(51) Int. Cl. H01F 1/00; C22C 38/00; C22C 38/60; C22C 38/42

(52) U.S. Cl. 335/297; 420/9; 420/10; 420/84; 420/91

(57) ABSTRACT

The invention relates to an austenitic iron-nickel-chromium-copper alloy, the composition of which comprises in % by weight:

24%≦Ni≦36%

Cr≧0.02%

Cu≧0.1%

Cu+Co≦15%

0.01≦Mn≦6%

0.02≦Si≦2%

0≦Al+Ti≦3%

0≦C≦2%

0≦V+W≦6%

0≦Nb+Zr≦0.5%

0≦Mo≦8

Sn≦1

0≦B≦0.006%

0≦S+Se+Sb≦0.008%

0≦Ca+Mg≦0.020%
the balance being iron and impurities resulting from the smelting, the percentage nickel, chromium, copper and cobalt contents being such that the alloy furthermore satisfies the following conditions:

Co<Cu

Co<4% if Cr>7.5%

Eq1>28% with Eq1=Ni+1.2Cr+(Cu/5)

Cr<7.5% if Ni>32.5%,
and the manganese content furthermore meeting the following conditions:

$$\begin{matrix}if Eq 3 \geq 205 , & Mn \leq Ni - 27.5 + Cu - Cr \\ if 180.5 \leq Eq 3 \leq 205 , & Mn \leq 4 \% \\ if Eq 3 \leq 180.5 , & Mn \leq 2 \%\end{matrix}$$

$$with Eq 3 = 6 Ni - 2.5 X + 4 ( Cu + Co )$$

$$and X = Cr + Mo + V + W + Si + Al .$$

The present invention relates to an austenitic iron-nickel-chromium-copper alloy intended more particularly for the manufacture of electromagnetic devices.

Nickel-rich iron-nickel and iron-nickel-chromium alloys have been known for a long time and used in many applications in electrical (electronic and electrotechnical) engineering, in displays, in energy transport, in heat regulation or electrical safety applications, thanks to their novel and varied physical properties.

Thus, they have thermal expansion coefficients between 20 and 100° C. of between 2 and 13×10⁻⁶/° C. depending on their composition, this being an exceptional characteristic for a ductile material, intrinsic in a few rare materials.

They also have good to very good aqueous corrosion resistance this being better the higher the nickel or chromium content.

A very high formability is also observed, due to the single-phase austenitic structure, which allows easy rolling down to very small thicknesses, and high-speed cutting, punching, stamping or drawing.

Their ferromagnetic behaviour, characterized by the existence of a Curie point T_{c} (the temperature at which the ferromagnetism disappears) is also remarkable as are their magnetic properties (relative permeability μᵣ, coercive field H_{c} and magnetic losses P).

Magnetic losses are very good, leading to a low energy consumption for magnetising these alloys. Thus, these iron-nickel and iron-nickel-chromium alloys have been used for a long time in electromagnetic applications in which it is imperative either to save energy (clock or watch electric motors, high-sensitivity residual-current circuit breaker relays, high-speed cool-running motors, etc.) or to have a very small hysteresis so as to significantly limit the dispersion in measurement from magnetic sensors (current transformers, DC sensors, resolvers and synchro-resolvers) or hysteresis losses (measurement transformer, modem transformer, etc.) or else to offer a highly preferential path for the magnetic flux lines as in certain magnetic actuator yokes with a large dynamic range (for example an electromagnetic petrol injector) in wheel motors or in high-attenuation passive magnetic windings.

Iron-nickel alloys, the coercive field of which is generally less than 125 mOe, thus make it possible to achieve a real drop in energy consumption in electrical systems compared with the conventionally used iron-silicon materials since the latter achieve coercive fields of around 190 mOe along only one direction, of interest only to few applications i.e. more generally ranging from 500 to 1250 mOe when the application requires the magnetic flux to travel in various directions in the material (for motors, generators, etc.).

However, there is a need to improve certain properties of these iron-nickel alloys, such as improvements in aqueous acid corrosion resistance and in salt-fog corrosion resistance, these not always being sufficient in certain aggressive environments.

Furthermore, the manufacture of sheets of these alloys includes industrial heat treatments in atmospheres that are often not very pure, resulting in the formation of an oxidized surface layer that protects the base metal from more extensive oxidation. However, this surface layer is not very adherent and is mechanically very weak, making its protective action not very effective.

The object of the present invention is to remedy these drawbacks by providing an alloy composition having improved aqueous acid corrosion resistance and salt-fog corrosion resistance, suitable for the formation of a strong adherent surface oxidation layer, which can be employed for many applications and has a low cost.

For this purpose, the first subject of the invention is an austenitic iron-nickel-chromium-copper alloy, the composition of which comprises in % by weight:

24%≦Ni≦36%

Cr≧0.02%

Cu≧0.1%

Cu+Co≦15%

0.01≦Mn≦6%

0.02≦Si≦2%

0≦Al+Ti≦3%

0≦C≦2%

0≦V+W≦6%

0≦Nb+Zr≦0.5%

0≦Mo≦8

Sn≦1

0≦B≦0.006%

0≦S+Se+Sb≦0.008%

0≦Ca+Mg≦0.020%
the balance being iron and impurities resulting from the smelting, the percentage nickel, chromium, copper and cobalt contents being such that the alloy furthermore satisfies the following conditions:

Co<Cu

Co<4% if Cr>7.5%

Eq1>28% with Eq1=Ni+1.2Cr+(Cu/5)

Cr<7.5% if Ni>32.5%,

and the manganese content furthermore meeting the following conditions:

$$\begin{matrix}if Eq 3 \geq 205 , & Mn \leq Ni - 27.5 + Cu - Cr \\ if 180.5 \leq Eq 3 \leq 205 , & Mn \leq 4 \% \\ if Eq 3 \leq 180.5 , & Mn \leq 2 \%\end{matrix}$$

$$with Eq 3 = 6 Ni - 2.5 X + 4 ( Cu + Co )$$

$$and X = Cr + Mo + V + W + Si + Al .$$

The solution proposed is a family of ferromagnetic austenitic Fe—Ni—Cr—Cu alloys which lend themselves to inexpensive industrial smelting, using an arc furnace or an induction furnace, which contain few expensive elements and which offer high or novel performance levels for several fields of applications that will be explained in detail below. Until now, it has never been found that a family of alloys could exhibit all these properties. Furthermore, by using the same alloy for very different applications (for example an alloy simultaneously meeting low-expansion, corrosion resistance, magnetism and Curie point requirements) it is possible to produce it in very large tonnage, to gain greater experience in industrial production and therefore to have a more reliable alloy in terms of reproducibility of its properties.

Moreover, the present inventors have observed the capability of silicon, chromium and copper for mechanically and chemically reinforcing the oxidized protective surface layer and for making it highly adherent. Thus, the oxidized layer becomes very stable over time from the heat treatment or use in an oxidizing ambient atmosphere, becomes chemically very stable with respect to external chemicals and becomes mechanically very stable with respect to impacts and rubbing between metal parts during the industrial production cycle.

Furthermore, this very stable oxide generally has a small thickness of a few microns, depending on the heat treatment cycle used. This small oxide thickness is particularly beneficial in watchwork, since it limits and calibrates at the same time the gap between stator and magnetic coil core, resulting, respectively, both in a limitation in the energy drawn from the battery by the watch and in a reduction in the variation of industrially manufactured watch or clock motors.

The invention will now be described in greater detail, but not limitingly, and illustrated by examples.

The alloy according to the invention has the contents in percent by weight defined below.

The nickel content is limited to 36%, preferably to 35%, more particularly preferably to 34%, and even 29% by weight. Such a limitation enables the cost of the grade to be greatly limited. It also makes it possible to have an electrical resistivity of at least 70 μΩ.cm or even at least 80 μΩ.cm if the nickel content is less than 34%, this being one of the elements of good dynamic magnetization performance (the other two elements being a low metal thickness and a low coercive field). For certain applications, such as the manufacture of bimetallic strips, it is preferred to keep the nickel content at 30% or higher so as to guarantee a high Curie point. The minimum nickel content is 24% so as to guarantee obtaining an austenitic structure within the entire composition range according to the invention.

The chromium content is equal to or greater than 0.02% as a minimum chromium content is necessary for having the required corrosion resistance properties. Moreover, when the nickel content is between 32.5% and 36%, the chromium content is limited to 7.5% so as to limit the cost of all the elements other than iron and silicon.

These features make it possible to improve the aqueous acid corrosion, atmospheric corrosion and hot oxidation corrosion resistance of the grade, since the formation of a chemically very stable surface oxide is observed, this being furthermore highly adherent to the metal. Moreover, the position of these elements does not significantly degrade the other usage properties of the alloy, such as the Curie point or the saturation magnetization.

The copper content is equal to or greater than 0.1% and is limited to a content of 15% and preferably to a content of 10% (so as to limit the cost of all the elements other than iron and silicon), with possible substitution by cobalt. Apart from its impact on the corrosion resistance of the grade, copper substantially improves the adhesion of the oxidized layer that forms on the surface of the alloy when hot.

It is preferable for the grade not to contain cobalt because of its cost and, for the same reason, if cobalt is present, it is necessary for its content to be below the copper content. Furthermore, when chromium is present in an amount of more than 7.5%, the cobalt must be limited to a maximum of 4% and preferably 2%, as it is desirable to limit the cost of all the elements other than iron and silicon.

The addition of at least 0.02% silicon significantly improves the mechanical wear resistance of the surface oxide layer. Furthermore, up to 2% silicon may be added to the alloy according to the invention in order to participate in its deoxidation in an arc furnace without impairing the other properties of the alloy.

Moreover, the present inventors have found that the nickel, chromium and copper contents must satisfy the following relationship:

Eq1>28% with Eq1=Ni+1.2Cr+(Cu/5).

This is because, by meeting this condition it is possible to guarantee the austenitic character of the alloy, without which none of the usage properties of the alloy would conform to the desired objectives and which would also prevent good formability being achieved.

The manganese content is between 0.01 and 6% by weight, and preferably between 0.02 and 6% by weight, which makes it possible to obtain an alloy that undergoes correct high-temperature transformation thanks to the formation of sulphides, without degrading the usage properties of the alloy, such as the Curie point and the saturation magnetization. To maintain values of the saturation induction Bₛ at above 4000 G, it is preferable for the manganese content to remain below 5%. More particularly preferably, the manganese content is between 0.1 and 1% by weight. Furthermore, in the presence of chromium, its effect on the saturation induction is aggravated, hence the need to limit it as follows:

$$\begin{matrix}Mn \leq Ni - 27.5 + Cu - Cr & if Eq 3 \geq 205 \\ Mn \leq 4 \% & if 180.5 \leq Eq 3 \leq 205 \\ Mn \leq 2 \% & if Eq 3 \leq 180.5\end{matrix}$$

$$with Eq 3 = 6 Ni - 2.5 X + 4 ( Cu + Co ) and$$

$$X = Cr + Mo + V + W + Si + Al .$$

The alloy may also contain addition elements such as carbon, titanium, aluminium, molybdenum, vanadium, tungsten, niobium, zirconium, tin, boron, sulphur, selenium, antimony, calcium and magnesium.

Carbon may be added to the alloy in an amount of 2% and preferably 1% in order to harden the alloy by deformation of carbides. However, when the application of the alloy requires a coercive field Hc of less than 125 mOe, the carbon content will be kept below 0.1% after smelting-solidification into an ingot or slab, since its presence greatly degrades this property. Moreover, to achieve this property (Hc) and maintain it over time, a decarburation heat treatment may be applied to the thin sheet in the final state so as to significantly reduce the carbon content to less than 100 ppm and preferably less than 50 ppm.

Titanium and aluminium may be added to the alloy in a combined amount of 3% so as to harden the grade by the precipitation of Ni₃(Ti,Al) compounds. The addition of aluminium may also improve the weldability of the alloy to glass. However, during heat treatment in a reducing gas, it is desirable to use cracked ammonia or a prior nitrogen/hydrogen mixture. Now, nitrogen combines during low-temperature annealing into compounds of the AlN or TiN type, and it is therefore necessary to reduce the content of Al and Ti residuals to as low as possible so as to ensure compatibility between high magnetic performance and heat treatment in a nitrogen-containing gas. This point applies in particular to any application requiring high magnetic performance and involving annealing operations in a nitrogen-containing atmosphere. In this situation, the combined content of titanium and aluminium is limited to 30 ppm and preferably to 20 ppm.

Molybdenum may be added in an amount of 8% in order to improve both the mechanical strength and the hot oxidation resistance of the alloy. Preferably, it is limited to 4% so as to limit the cost of the elements other than Fe and Si.

Vanadium and tungsten may be added to the alloy in a combined amount of 6%, so as to improve its toughness, and are preferably added in an amount of less than 3% so as to limit the cost of all the elements other than iron and silicon.

Niobium and zirconium may be added to the alloy in a combined amount of 0.5% so as to improve its mechanical strength.

Tin may be added to the alloy in an amount of 1% as a partial substitution for chromium.

Boron may be added to the alloy according to the invention in amounts ranging from 2 to 60 ppm, preferably from 5 to 10 ppm, so as to improve its cutability through the formation of boron nitrides. Below this range, its effect is no longer observable, whereas above 60 ppm its effect saturates.

Sulphur is an impurity present in the scrap iron used for smelting the alloy, but it may also be added in amounts ranging from 5 to 80 ppm, and preferably 10 to 30 ppm, again to improve cutability but also machinability of the alloy through the formation of manganese sulphide. All or some of the sulphur may be substituted by the addition of selenium and/or antimony.

When sulphur and boron are added as cutability additives, their combined content is between 5 and 60 ppm, but preferably these two elements are combined, respecting their own preferred respective range.

Likewise, calcium and magnesium may be added to the alloy according to the invention in a combined amount of 4 to 200 ppm in order to improve cutability through the formation of compounds of the MgO or CaO type, the broad Ca+Mg range enabling the compromise between cutability and magnetic performance to be adjusted, since unlike certain sulphides (MnS, etc.) and nitrides (AlN, etc.) a high-temperature reducing anneal will be unable to dissolve said compounds at the end of manufacture.

The rest of the composition consists of iron and inevitable impurities arising from the smelting. Among these, mention may more particularly be made of phosphorus, nitrogen and oxygen which are contained in an amount of at most 500 ppm. For certain applications, it is necessary to limit the combined oxygen and nitrogen content to 100 ppm so as to maintain the coercive field within the desired limits.

In general, the alloy according to the invention may be smelted and produced in the form of hot-rolled strip, which is then cold-rolled before being annealed and then optionally work-hardened. It is also possible to stop at the hot-rolled strip state.

The alloy according to the invention may also be used in the form of bulk products, which may or may not be forged, or in the form of bar stock or rod stock obtained from hot rolling and optionally completed by a wire-drawing operation.

The alloy strip or part may be obtained by any suitable process such that a person skilled in the art would know how to carry out.

Thus, the alloy according to the invention will preferably be melted in a vacuum induction furnace and cast into ingots. The ingots may be forged between 1100 and 1300° C. and then hot-rolled down to a thickness of 2.5 mm between 1000 and 1200° C. The hot-rolled strip may then be chemically pickled before being cold-rolled down to the required thickness.

When it is desired to develop a particular crystallographic structure of the {100}<001>type, a cold-rolling operation is carried out with an overall reduction ratio of 90 to 99% in several passes without intermediate annealing between each pass.

After the cold-rolling, an anneal is preferably carried out for one hour at between 800 and 1100° C. in order to soften the alloy strip and thus make it easier to cut it or to form it subsequently. However, it may be even more advantageous for cutting, by high-speed stamping or punching, to take place in the work-hardened state at the end of cold rolling, especially if the metal has been optimized with respect to this processing by the aforementioned elements, such as B, S, Ca, Mg, Se, etc.

After cutting or forming, the parts obtained may advantageously be annealed at 1100° C. for 3 hours in purified H₂ (dew point <−70° C.), in particular to optimize the magnetic properties of the alloy. However, this annealing may be completely unnecessary if expansion or Curie point or corrosion resistance properties are particularly sought.

As was seen above, the alloys according to the invention may be produced with industrial annealing in any type of gas.

The alloys according to the invention find potential applications in many fields. Thus, preferred compositional ranges, bringing together alloys that are more particularly suitable for a given application, may be defined, and these will be described in detail below.

Electromagnetic Devices with Temperature Self-Regulation

In a first preferred embodiment, the percentage nickel, chromium, copper, cobalt, molybdenum, manganese, vanadium, tungsten, silicon and aluminium contents are such that the alloy furthermore satisfies the following conditions:

$$\begin{matrix}0.02 \leq Mn & \\ Eq 2 \geq 0.95 with & Eq 2 = ( Ni - 24 ) [ 0.18 + 0.08 ( Cu + Co ) ] and \\ Eq 3 \geq 161 and & \\ Eq 4 \leq 10 with & Eq 4 = Cr - 1.125 ( Cu + Co ) and \\ Eq 5 \leq 13.6 with & Eq 5 = Cr - 0.227 ( Cu + Co ) and \\ Eq 6 \geq 150 with & Eq 6 = 6 Ni - 2.5 X + 1.3 ( Co + Cu ) and \\ Eq 7 \geq 150 with & Eq 7 = 6 Ni - 5 Cr + 4 Cu .\end{matrix}$$

This composition is particularly suitable for the manufacture of electromagnetic devices with temperature self-regulation.

A soft ferromagnetic material has a permeability μ which is very much greater than the permeability of free space. When this material is subjected to magnetic excitation that varies over time, it generates much higher magnetic losses before reaching a characteristic value called the Curie point T_{c} than when it exceeds this temperature, above which the material is no longer ferromagnetic. In addition, the saturation magnetization of the material, its magnetic losses and therefore its thermal power generation progressively decrease as the temperature approaches T_{c}.

Temperature self-regulation is therefore established around the Curie point of the alloy if the residual magnetic losses specific to each non-magnetic conductor are dissipated, that is to say the heat flux leaving the alloy is greater than the heat flux generated by the magnetic losses. To do this, it is sometimes necessary to juxtapose with the alloy according to the invention a material which is a much better thermal conductor, such as aluminium or copper, this material being responsible for dissipating the paramagnetic losses and, in particular, allowing temperature self-regulation in cooking applications employing induction heating in which the heat from a vessel heated inadvertently when empty can only be dissipated by natural convection.

This technique has in particular been described in patent application EP 1 455 622 in which the temperature self-regulation is obtained by combining alloys having a low T_{c}, between 30 and 350° C. and containing at least 32.5% nickel with an aluminium heat sink enabling the magnetic losses of the Fe—Ni—Cr alloy to be dissipated when it reaches T_{c}.

The main usage property therefore remains the functional Curie point which is desirably between 30° C. and 400° C. for cooking by induction heating, or industrial induction heating, for example for injector and composite-mould nozzles, for warming beverages, food, medical products, blood and constituents, soft or organic materials, etc.

A minimum corrosion/oxidation resistance is also desired since the alloys are often in contact with various media and/or constituents in industrial atmospheres. Thus, good chemical stability of the alloy is required, manifested by good aqueous corrosion resistance and good salt-fog corrosion resistance, and good mechanical stability (adhesion+wear resistance) of the oxidized surface layer in hot oxidizing atmospheres.

Moreover, it is also preferable to seek alloys having an expansion coefficient between 20 and 100° C. of greater than 4×10⁻⁶/° C. or even greater than 7×10⁻⁶/° C. This characteristic makes it possible in particular to reduce any bimetallic effect that may exist between the alloy and a conducting layer closely associated with the alloy, by cladding, gripping, welding, plasma deposition, etc.

On the other hand, there is no particular requirement on the magnetic properties and the coercive field may be greatly degraded. It is therefore possible to add large amounts of carbon, of around 2% at most and preferably less than 1%. This is because it has been known for a long time that carbon in a large amount greatly strains the crystal lattice and thus increases the exchange interaction between magnetic moments, and therefore increases the Curie point. This makes it possible for the nickel percentage content to be further reduced in order to maintain the same Curie point level and therefore the same self-regulation temperature.

However, the temperature self-regulation application is not restricted to the cooking of liquid and solid food by induction heating, but more generally pertains to any domestic or industrial system using an electromagnetic inductor and at least one thermally active part on transition elements that have to be momentarily heated without exceeding a certain critical temperature.

One example that may be mentioned is the injection of relatively viscous fluids, whether or not relating to food, in order to increase the rate of production of a portion of material preheated for tasting, or also as a prerequisite before another industrial operation, such as thermally activated bonding, or the curing of plastics and composites, etc.

The rapid self-regulated surface heating of forming moulds for thermosetting composites (requiring the temperature to be regulated between 200 and 350° C. depending on the type of composite) or thermoplastic composites (with the requirement to regulate the temperature between 150 and 250° C. depending on the type of composite) may also be mentioned.

Another example that may be mentioned is the self-regulated heating of a needle or insert made of a low T_{c} alloy made bio-compatible by a coating, at the centre of a malignant tumour (the cells of which are more sensitive to heat than normal cells).

A final example that may be mentioned is the self-regulated heating of an extrusion die, spinneret for melt spinning, etc., making it possible to limit the thermal gradient in the part processed through the die or spinneret, thus limiting internal stresses, surface embrittlement, property gradients, structural inhomogeneities, etc.

The alloys according to the invention as defined above enable all the required properties to be achieved.

In particular, the inventors have found that when the limit values in equations 2 to 7 are satisfied, it is possible to ensure not only a level of saturation induction at 20° C. greater than 0, and even greater than 1000 G, allowing heat emission through magnetic losses, but also a Curie point Tc≧30° C.

More generally, and whatever the application according to the invention, it has been found that by adapting the composition of the alloy it is possible to modify the value of each of equations 2 to 7 so as to meet the limit value imposed in a particular application, and thus regulate the level of induction and the T_{c} value of the alloy in question.

Devices with Magnetic Flux Self-Regulation

In another preferred embodiment, the alloy may furthermore be such that:

$$\begin{matrix}Ni \leq 29 \% & \\ Co \leq 2 \% & \\ 0.02 \leq Mn \leq 2 \% & \\ Eq 2 \geq 0.95 with & Eq 2 = ( Ni - 24 ) [ 0.18 + 0.08 ( Cu + Co ) ] and \\ Eq 3 \geq 161 and & \\ Eq 4 \leq 10 with & Eq 4 = Cr - 1.125 ( Cu + Co ) and \\ Eq 5 \leq 13.6 with & Eq 5 = Cr - 0.227 ( Cu + Co ) and \\ Eq 6 \geq 150 with & Eq 6 = 6 Ni - 2.5 X + 1.3 ( Co + Cu ) and \\ Eq 7 \geq 160. & \end{matrix}$$

This composition is particularly suitable for the manufacture of devices with magnetic flux self-regulation.

The magnetic flux regulation of a device as a function of the ambient temperature relies on the decrease in saturation magnetization with a temperature close to the Curie point, with a substantially constant and quite high rate of decrease. A flux diversion system provides precise compensation for the decrease in magnetization of the magnets by varying the magnetic flux cross section between magnet and compensation alloy and thus always provides the same magnetic flux within a given temperature range.

This magnetic flux self-regulation is usually achieved around the ambient temperature, and in particular between 30° C. and +100° C. There is therefore a need for various alloys having a Curie point T_{c} within this temperature range.

However, there is no particular requirement on the magnetic properties, and in this situation the coercive field may be highly degraded relative to the 10 A/m limit corresponding to the performance potential of the novel alloys according to the invention. As previously, the carbon content may be adjusted up to 2% and preferably up to 1%.

### Controlled Expansion Devices

In another preferred embodiment, the alloy may furthermore be such that:

$$\begin{matrix}Ni \leq 35 \% & \\ 0.02 \leq Mn & \\ C \leq 0.5 \% & \\ Eq 2 \geq 1 & \\ Eq 3 \geq 170 & \\ Eq 4 \leq 10 with & Eq 4 = Cr - 1.125 ( Cu + Co ) and \\ Eq 5 \leq 13.6 with & Eq 5 = Cr - 0.227 ( Cu + Co ) and \\ Eq 6 \geq 159 & \\ Eq 7 \geq 160 with & Eq 7 = 6 Ni - 5 Cr + 4 Cu .\end{matrix}$$

This composition is more particularly suitable for the manufacture of controlled expansion devices.

The term “controlled expansion alloys” is understood to mean alloys having lower expansion coefficients than other metallic alloys (α₂₀₋₁₀₀>10×10⁻⁶/° C.), i.e. typically α₂₀₋₁₀₀<10×10⁻⁶/° C. or α₂₀₋₃₀₀<13×10⁻⁶/° C.

These alloys are used in applications requiring the geometry and dimensions of certain of these components to be precisely maintained as a function of temperature, or else requiring a high level of compatibility in terms of thermal expandability between one of these active materials and a controlled expansion alloy, providing other functions (for example current conduction or mechanical support function). These applications have in common the fact that the components undergo temperature variations within a range from 20 to 450° C.

For some applications, it is thus necessary for there to be close compatibility in terms of thermal expansion with another active material (silicon, germanium, GaAs, SiC, soda glass, another glass, low-expansion stainless steel, ceramic, etc.) in the application. This close compatibility between another material and the alloy makes it possible for both these two materials, linked together by cladding, welding, bonding, braising, gripping, etc. to expand together without modifying their shape, the dimensions changing only in a predictable manner as a consequence of the general thermal expansion law. Another advantage of this close expansion compatibility is that there is a very low level of thermally induced internal stresses between the two materials. This makes the thermal fatigue negligible during operation of the two-material device, thus considerably extending its lifetime.

One of these applications is in the integrated circuit connection field (as a leadframe) in which the alloy is closely bonded to the semiconductor in order to supply it with electrical current. It is thus necessary to employ a controlled expansion alloy in order to greatly limit thermal fatigue and premature deterioration of the interface.

Another application is for low-expansion mechanical support within a predefined temperature range. For example, a video projector uses numerous small mirrors, the positions of which must move as little as possible when the apparatus heats up, by which the support for the mirrors may be brought locally to a temperature of 400-450° C.

Another application is of the fabrication of supports and packages for transistors, circuit semiconductors in optoelectronics (for example, made of GaAs), X-ray tubes, sealed penetrations for glasses, etc.

In all these applications, the controlled expansion alloy is closely bonded to a semiconductor or a glass or a ceramic, and the requirements in terms of expansion coefficients may range from 4 to 5×10⁻⁶/° C. to 11×10⁻⁶/° C. One example that may be mentioned is for supporting/bending of two vehicle sunroofs (whether opening or not), in which the alloy must necessarily expand with the adhesive that bonds them in the same way as the glass panel. Mention may also be made of low-deformation supports for piezoelectric ceramics such as PZTs used as automatic fuel injection actuators.

It is also possible for the controlled expansion alloy to provide only this single function in the application, while still being capable of being precisely formed by bending, drawing, stamping, flow turning, mechanical machining, chemical milling (etching), welding, etc. In this case, the mechanical part having precise dimensions produced in the controlled expansion alloy has the advantage of having a low and predefined expansion within a wide temperature range. Thus, the parts of an electron gun heat up through the effect of the electrons, offering them only certain holes for them to pass through (sizing of the electron beam), which is the function of these parts: there is therefore a need for an alloy which expands as little as possible within the entire working temperature range and has good formability.

Apart from expandability, good aqueous acid corrosion resistance, good salt-fog corrosion resistance and good mechanical wear resistance of the oxide layer are desirable properties. These properties are obtained with inexpensive industrial annealing (low or degraded dew point) or in harsh environments without the need for additional protection.

These alloys therefore represent good substitutes for conventional FeNi alloys, while containing less nickel than them.

### Current Sensors, Measurement Transformers and Magneto-Harmonic Sensors

In another preferred embodiment, the alloy may furthermore be such that:

$$\begin{matrix}Cu \leq 10 \% & \\ 0.02 \leq Mn & \\ C \leq 0.1 & \\ Eq 2 \geq 1 & \\ Eq 3 \geq 170 & \\ Eq 4 \leq 10 with & Eq 4 = Cr - 1.125 ( Cu + Co ) \\ Eq 5 \leq 13.6 with & Eq 5 = Cr - 0.227 ( Cu + Co ) \\ Eq 6 \geq 159 & \\ Eq 7 \geq 160 with & Eq 7 = 6 Ni - 5 Cr + 4 Cu .\end{matrix}$$

This composition is more particularly suitable for the manufacture of current sensors or measurement transformers.

Preferably, the desired objective is the capability of obtaining good magnetic performance in any type of industrial non-oxidizing atmosphere, such as inert gas, He, H₂, N₂, NH₃ etc., thereby forcing the titanium content to be reduced as much as possible, preferably <30 ppm Ti, preferably <20 ppm Ti.

The expression “current sensors or measurement transformers” is understood to mean devices for detecting current or magnetic field with the objective of warning of a threshold violation (electronic residual-current circuit breaker) or of a current measurement or field (current or voltage transformer, energy counter, DC sensor).

This type of application requires most particularly a low coercive field, whereas the saturation magnetization may be low (4000 to 8000 G at 20° C.) as for example in many closed-loop current sensor cases, or else may be high (>10000 G) as in the case of open-loop current sensors.

The main parameter of the application is the measurement precision, which is highly dependent on the coercive field of the alloy used, and in many cases the B—H linearity of the magnetization curve or hysteresis cycle, the lower H_{c}, the better the precision measurement.

For some applications, such as transformers/current sensors with a wide frequency band, a very low dynamic hysteresis is required in order to guarantee good measurement precision and moderate frequencies, which may be achieved by closed-loop structures operating at low induction, but also by choosing materials having a low H_{c} and a high electrical resistivity.

To summarize, a material suitable for these applications must have the following characteristics:
induction Bₛ at 20° C. from 4000 G to more than 13000 G depending on the application;
H_{c}<75 mOe (preferably <37 mOe); and
electrical resistivity ρₑₗ>60 μΩ.cm (preferably ρₑₗ>70 μΩ.cm).

In certain applications, linearity of the B—H magnetization curve up to the break in the magnetization curve is also desirable. This linearity is characterized by the Bᵣ/Bᵣ, ratio, i.e. the ratio of the remnant induction to the measured induction, in the saturation approach zone. If Bᵣ/Bₘ<0.3, the linearity becomes exploitable in these specific applications with magnetic cores without a localised gap.

The alloys according to the invention allow all these properties to be achieved.

The composition suitable for these applications is also suitable for the manufacture of magneto-harmonic sensors.

In this application, a material having a high permeability and a low coercive field is subjected to the relatively high magnetic polarization of a semi-remnant magnetic material—the magnetization state (magnetized, demagnetized or partially magnetized) of this material corresponds to information or an alarm which is transmitted to the soft material through the polarization of the latter. The soft material is excited at moderate frequencies by an external magnetic field, producing no harmonic, few harmonics or many harmonics of the fundamental emitted, depending on whether the soft material was subjected to a demagnetized, partially magnetized or magnetized semi-remnant state, respectively. Thus, the detected amplitude of the harmonic is the image of the level of polarization of the semi-remnant state.

For example in a library, this device is slipped in the magnetized state into the jacket of each book stored. When the book is borrowed, it is registered and at the same time demagnetized so as to pass unencumbered through the security doorway (no harmonic emission). If the book has not been demagnetized by the specific apparatus, the high level of harmonic emission triggers the sounding of a warning signal as the book passes towards the exit under the detection gateway.

To react dynamically to such pulses requires a high dynamic magnetization performance, i.e. a high electrical resistivity, a very low strip thickness, typically less than 50 μm, and preferably less than 30 μm, and a low coercive field, typically H_{c} less than 63 mOe and preferably less than 25 mOe. The coercive field also controls to a 1^{st} order the sensitivity of the magneto-harmonic sensor and enables it to be triggered further away from the excitation antenna the lower the H_{c}. The coercive field is the most constricting property as regards the range of composition, which must be limited in terms of copper for this reason.

To summarize, a material suitable for these applications must have the following characteristics:
H_{c}<63 mOe (preferably <25 mOe) both for having good sensitivity of the sensor to the excitation field at moderate frequency and to limit the dynamic hysteresis (and therefore enhance the dynamic magnetization performance)
the electrical resistivity rₑₗ>60 μΩ.cm (preferably rₑₗ>80 μΩ.cm) in order to have a good dynamic response to the external excitation at moderate frequency.

The alloys according to the invention make it possible to achieve all these properties.

### Motors and Electromagnetic Actuators

In another preferred embodiment, the alloy may furthermore be such that:

0.05%≦Mn≦2%

C≦0.1

Eq2≧1.5

Eq3≧175

Eq4≦7 if Ni≦32.5, or Eq4≦10 if Ni>32.5

Eq5≦10.6 if Ni≦32.5, or Eq5≦13.6 if Ni>32.5

Eq6≧164

Eq7≧160 with Eq7=6Ni−5Cr+4Cu.

This composition is more particularly suitable for the manufacture of motors and electromagnetic actuators.

Preferably, the desired objective is the capability of obtaining good magnetic performance in any type of industrial non-oxidizing atmosphere, such as inert gas, He, H₂, N₂, NH₃ etc., thereby forcing the titanium content to be reduced as much as possible, preferably <30 ppm Ti, preferably <20 ppm Ti.

The motors and electromagnetic actuators that can be manufactured according to the invention have a moderate to high volume power, a high movement precision, a low dissipation and a low cost.

Included within this application are all non-polarized electromagnetic devices, comprising a moving part (rotor for a rotary system such as a motor, alternator, synchro-resolver, reluctant torque sensor, wheel motor, etc., or armature or core for translational movement systems such as a linear motor, solenoid valve, injector, camless-type impulsive linear actuator, etc.) made of a soft magnetic material having a high electrical resistivity and low magnetic losses, and a static part comprising a magnetized magnetic material.

The devices according to the invention have in particular the following characteristics:
a fairly small to very small size, depending on the transferred power in the application, knowing that the higher the power of the actuator or sensor or motor, the more important it is to have a material having a high saturation. This implies a saturation induction greater than 5000 G;
a low energy dissipation (or good energy efficiency) thanks to a high electrical resistivity (>70 μΩ.cm), a low H_{c} (<125 mOe) and quite a high DC permeability (>5000μ₀); and
good precision in placing the moving part, by greatly reducing the unidirectional or rotational dynamic hysteresis effect (obtained with H_{c}<125 mOe and preferably <75 mOe). This property is most particularly important in the case of variable-reluctance torque sensors, for resolvers and synchro-resolvers and more generally for all rotary systems having a low gap reluctance.

In this type of application, the magnetic yokes may be made up by stacking cut parts, with quite small thicknesses (>0.1 mm, preferably 0.15 mm) making it possible to minimize the macroscopic induced currents, magnetic losses and the dynamic hysteresis effect; in systems with unidirectional magnetic actuation (solenoid valves, electro-injection, camless actuator, gas safety actuation, for example), rather use is made of a thick sheet or a wire made in the form of the final yolk by drawing/forming/pressing/machining, etc., before the final anneal.

In the case of devices operating with rotating magnetic fields (for example rotary systems), it is preferable for the alloy to have the best possible isotropy of its magnetic performance, as otherwise this introduces torque oscillations depending on the rotation step (in the case of motors), magnetic reluctance fluctuations depending on the position of the moving part (in the case of a synchro-resolver, reluctant torque sensor, etc.). The problem is solved either by using rolling/annealing sequences that do not develop a crystallographic texture, or by developing a “planar”-type texture, for example a {100}<0vw> or {111}<uvw> texture.

In the case of a non-polarized electromagnetic safety actuator device, such as those used for preventing domestic gas leaks in gas heating systems (for example a water heater), the device has to have a low trip current and a low release current (and also a low difference between these currents), this necessarily involving low coercive fields (see above) and small gaps between magnetic yoke and moving core of the actuator, but also low remanence in order to guarantee release even with very small gaps, in order to reduce the difference between trip and release currents and to reduce manufacturing variation in the performance of the device. In particular, in this application case, it is desirable to have Bᵣ/Bₘₐₓ<0.5 and preferably <0.3 (induction Bₘₐₓ for a magnetic field at least equal to 3H_{c}).

The alloys according to the invention make it possible to achieve all these properties.

### Stators for Watch Motors

In another preferred embodiment, the alloy may furthermore be such that:

0.05%≦Mn≦2%

C≦0.1

Co≦1.8%

O+N≦0.01%

Eq2≧1.5

Eq3≧175

Eq4≦7 if Ni≦32.5, or Eq4≦10 if Ni>32.5

Eq5≦10.6 if Ni≦32.5, or Eq5≦13.6 if Ni>32.5

Eq6≧164

Eq7≧160 with Eq7=6Ni−5Cr+4Cu,

the alloy furthermore satisfying at least one of the following relationships:

0.0002≦B≦0.002%

0.0008≦S+Se+Sb≦0.004%

0.001≦Ca+Mg≦0.015%.

This composition is more particularly suitable for the manufacture of stators for clock or watch motors, particularly of the stepper type.

Preferably, the desired objective is the capability of obtaining good magnetic performance in any type of industrial non-oxidizing atmosphere, such as inert gas, He, H₂, N₂, NH₃ etc., thereby forcing the titanium content to be reduced as much as possible, preferably <30 ppm Ti, preferably <20 ppm Ti.

For this type of application, the aim is to provide low-cost alloys while still satisfying a certain number of properties.

The first aim is to have good cutability of the alloy strip by punching, stamping or any other suitable process, allowing low tool wear and high cutting rates. Specifically, the metal is delivered by the producer in the work-hardened or softened state so as to maintain a sufficient mechanical hardness of the metal propitious for high-speed cutting by stamping. However, this hardness is not sufficient to cut hundreds of thousands of stator parts without producing significant burrs and without wearing away the cutting die, and in particular the cutting punch to the point of having to resharpen or replace it. To achieve this, it is also necessary to insert into the metal certain fine inclusions with the function of “cutting along a dotted line” during the cutting process between punch and die. In addition, the fine inclusions must be able to be removed during the subsequent high-temperature annealing for optimizing the magnetic properties. This is why the alloys according to the invention intended for this application incorporate 8 to 40 ppm of S, Se, Sb and/or 2 to 20 ppm and/or 10 to 150 ppm of Ca, Mg.

The next aim is to have a saturation induction Bₛ that has to be greater than 4000 G at 60° C., but preferably less than 7000 G.

The aim is also to minimize the electrical power consumption of the watch motor when it is used at its nominal power, i.e. when the magnetic alloys of the stator work close to the kink in the B—H magnetization of the material.

To do this, for a stator thickness limited to a minimum of 0.4 mm, below which the mechanical strength would no longer be sufficient, the alloy must have an electrical resistivity of more than 70 μΩ.cm, and preferably greater than 80 μΩ.cm, and a low coercive field H_{c} of less than 125 mOe and preferably less than 75 mOe before being fitted into the watch.

Moreover, the power consumption of the watch must not increase significantly when the ambient temperature rises. This is because if the work magnetization decreases significantly when the temperature increases, then to always provide the minimum torque with rotation of a half-turn of the rotor, the energy generator must deliver more energy in order to retain the level of magnetization of the stator and therefore the driving torque that is applied to the rotor. Thus, in the case of a watch being used in a hot atmosphere, the consumption will increase substantially.

To control the electrical power consumption when the ambient temperature increases, it is therefore necessary for the saturation magnetization Jₛ to remain stable within the potential operating range of the watch, mainly from −40° C. to +60° C.: such a characteristic is automatically obtained when the Curie point of the T_{c} of the alloy is equal to or greater than 100° C.

Another aim is to have good corrosion resistance. This is because the magnetic parts of the stator, once they have been cut and undergone the heat treatment to optimize the magnetic performance, are stored, transported and then fitted in the open air into watch movements. These fitting operations are being increasingly carried out in countries where a high level of atmospheric corrosion exists, especially corrosion of salt type or that due to atmospheric pollution (sulphur, chlorine, etc.).

The requirement for acid corrosion resistance will vary depending on the desired quality and the desired lifetime of the watch. This is because the lifetime of the watch will not exceed the time for appreciable degradation of the stator alloy by atmospheric corrosion. If the clock motor is of a quality for reknown manufacturing zones called “Swiss-made” or “Japan-made”, the watch is made to last a few years, and the watch alloy must not corrode significantly over this period of time. If it is a top-of-the-range clock motor or a transparent watch with in particular visible parts of the motor, the latter must in principle operate without any problem for the lifetime of a person.

The various levels of corrosion resistance may then be as follows:

bottom-of-the-range watch movement: minimal corrosion resistance with I^{ox}ₘₐₓ≦5 mA,

“Swiss-made” or “Japan-made”-type quality watch movement: intermediate corrosion resistance with Iₘₐₓ 3 mA, and

visible operating watch movement (transparent watch) or lifetime guarantee: high-performance corrosion resistance with I^{ox}ₘₐₓ≦1 mA.

### Inductors and Transformers for Power Electronics

In another preferred embodiment, the alloy may furthermore be such that:

Cu≦10%

0.02≦Mn

C≦0.1

Eq2≧1.5%

Eq3≧189

Eq4≦4 if Ni≦32.5, or Eq4≦7 if Ni>32.5

Eq5≦4 if Ni≦32.5, or Eq5≦7 if Ni>32.5

Eq6≧173

Eq7≧185.

This composition is more particularly suitable for the manufacture of inductors and transformers for power electronics.

The magnetic circuits of passive magnetic components used in power electronics or in any other moderate-frequency energy conversion system (operating from a few hundred Hz to a few hundred kHz) require the use of smoothing inductors or transformers that often constitute bulky parts of power supplies.

When designing these components, it is not only the saturation magnetization of the magnetic core but also the conductor losses via Joule heating and the magnetic losses generated in and dissipated by the entire component that set the achievable potential for volume reduction due to the soft magnetic material used.

It follows that a good magnetic core of a passive magnetic component of the storage inductance or smoothing type, or a power transformer, must firstly have a high saturation induction at the operating temperatures, which typically are around 100-120° C. The aim is thus to have a saturation induction Bₛ^{100° C.} equal to or greater than 4000 G, which corresponds to a saturation induction at 20° C., namely Bₛ^{20° C.} which is greater than 8000 G or else at a Curie point T_{c} equal to or greater than 150° C.

It must also have low magnetic losses at the operating temperatures, corresponding, for metal thicknesses of at most 50 μm, to an electrical resistivity at 100° C. of greater than 60 μΩ.cm and preferably greater than 100 μΩ.cm, and to a low dynamic hysteresis characterized by a coercive field H_{c} at 100° C. of less than 75 mOe and preferably less than 37.5 mOe. The requirement is therefore only for the coercive field H_{c} at 20° C. to be equal to or less than 75 mOe and preferably less than 37.5 mOe. This is because it is well known to those skilled in the art that H_{c} decreases with temperature in soft magnetic materials when the temperature approaches the Curie point, and thus the performance at 100° C. will be obtained a fortiori if the performance at 20° C. has been guaranteed.

In addition, the residual losses of the alloys according to the invention may be compensated for by better capability of dissipating these losses thanks to the high thermal conduction of the metal alloys and to the very high formability and processibility of these highly ductile magnetic yokes and making it possible for easy installation therein of cooling circuits or for giving a magnetic circuit a complex shape.

### Bimetallic Strips

In another preferred embodiment, the alloy may furthermore be such that:

Ni≧30%

0.025≦Mn

C≦1%

Eq2≧1.5

Eq3≧189

Eq4≦4 if Ni≦32.5, or Eq4≦7 if Ni>32.5

Eq5≦4 if Ni≦32.5, or Eq5≦7 if Ni>32.5

Eq6≧173

Eq7≧185

Eq8≧33 with Eq8=Ni+Cu−1.5Cr.

This composition is more particularly suitable for the manufacture of bimetallic strips.

In this application, a change in temperature may be converted either into deformation of the bimetallic strip, or into a rise in the end of the bimetallic strip, the other end being kept in position, or into a force exerted by the free end of the bimetallic strip, thanks to the close bonding of two materials in narrow gap strip form that have different expansion coefficients.

Bimetallic strip parts may also serve as overcurrent sensors through the electrical resistivity of the multilayer material and its deflection, temperature sensors through the deflection of the bimetallic strip which then cuts off an electrical circuit, or else thermomechanical actuators through the force generated by the imbalanced expansion of the various constituents of the bimetallic strip. In all cases, the action of the bimetallic strip takes place via its detection, the amplitude of which is proportional to the difference in expansion coefficient between the two external constituents of the bimetallic strip. The sensitivity of the bimetallic strip actuator will be higher the larger the difference in expansion coefficients for a given strip thickness and/or a given temperature difference.

The aim is therefore to have a material with an average expansion coefficient α₂₀₋₁₀₀ between 20° C. and 100° C. that does not exceed 7×10⁻⁶/° C. and preferably does not exceed 5×10⁻⁶/° C. and at the same time an average expansion coefficient α₂₀₋₃₀₀ that does not exceed 10×10⁻⁶/° C. and preferably does not exceed 8×10⁻⁶/° C., in order to allow use over a wide temperature range.

Another important parameter when the source of heat derives from the electrical current flowing through the bimetallic strip is the electrical resistivity ρₑₗ. Thus a bimetallic strip with a high average electrical resistivity will heat up much more and rise to a higher temperature than a bimetallic strip having a low electrical resistivity. This will result either in a deflection amplitude of the bimetallic strip in the same ratio, or a force of the bimetallic strip actuator in the same ratio. In addition, the electrical resistivity is inversely proportional to the thermal conductivity, which thereby ensures temperature uniformity and therefore the dynamic response of the bimetallic strip.

Materials are therefore sought which have an electrical resistivity ρₑₗ at 20° C. of greater than 75 μΩ.cm, preferably greater than 80 μΩ.cm.

Moreover, while adding a third metal layer, such as copper or nickel, between the layers having low and high expansion coefficients it is possible to adjust various resistivity/conductivity compromises without changing the expansion coefficients.

Furthermore, it is necessary to have a material with a Curie point T_{c} equal to or higher than 160° C., and preferably higher than 200° C. in order to maintain good temperature stability of the expansion properties.

To obtain this high Curie point, this low expansion coefficient and this high electrical resistivity, it is necessary for the alloys according to the invention to have more than 30% nickel and to satisfy equation 8 defined by:

Eq8=% Ni+% Cu−1.5% Cr≧33.

### Watch Motor Coil Cores and High-Sensitivity Electromagnetic Relays

In another preferred embodiment, the alloy may furthermore be such that:

0.05%≦Mn≦2%

C≦0.1

Eq2≧2

Eq3≧195

Eq4≦2 if Ni≦32.5, or Eq4≦6 if Ni>32.5

Eq5≦2 if Ni≦32.5, or Eq5≦6 if Ni>32.5

Eq6≧180

Eq7≧190.

This composition is more particularly suitable for the manufacture of the cores of clock or watch motor coils and high-sensitivity electromagnetic relays.

Preferably, the desired objective is the capability of obtaining good magnetic performance in any type of industrial non-oxidizing atmosphere, such as inert gas, He, H₂, N₂, NH₃ etc., thereby forcing the titanium content to be reduced as much as possible, preferably <30 ppm Ti, preferably <20 ppm Ti.

With a general objective of low power consumption of the watch, the magnetic field intended to magnetize the watch magnetic circuit must be produced with a minimum electrical current, i.e. with the maximum number of turns of the excitation coil, which means using a very thin wire and a magnetic core with a high magnetic flux so as to reduce the cross section of the core and place as large a coil as possible thereon.

The magnetic alloy of the core must therefore necessarily operate high magnetic saturation since the magnetic flux is the product of the magnetization multiplied by the cross section of the material. Alloys are therefore sought that have a saturation induction Bₛ at 20° C. greater than 10000 G.

The alloy must also have a low coercive field H_{c} and a high electrical resistivity in order to reduce the magnetic losses and thus limit the power consumption of the watch. Alloys are therefore sought which have a coercive field H_{c} at 20° C. which is less than 125 mOe and preferably less than 75 mOe and an electrical resistivity ρₑₗ which is greater than 60 μΩ.cm and preferably greater than 80 μΩ.cm.

Furthermore, the alloys according to the invention intended for this application preferably have good cutability and therefore may optionally incorporate 8 to 40 ppm of S, Se, Sb and/or 2 to 20 ppm and/or 10 to 150 ppm of Ca, Mg.

The alloys according to the invention make it possible to achieve all these properties.

In a preferred embodiment, the alloys according to the invention have a saturation induction Bₛ of greater than 13000 G and their composition must therefore satisfy equation 9:

Eq9≧13000 with Eq9=1100(Ni+Co/3+Cu/3)−1200Cr−26000.

The compositions suitable for manufacturing watch motor coil cores are also suitable for the manufacture of high-sensitivity electromagnetic relays.

An electromagnetic relay is an electrically controlled mechanical actuator in which a magnetic yoke, generally a solid yoke for ease and low cost of production/forming, is closed off by a piece of material and in a switching position on one end of the yoke leg. The switching position, for switching between “open” state and “closed” state, results from the balance between a mechanical restoring force of a spring (placed outside the yoke and tending to open the magnetic circuit by making the movable armature pivot about the yoke leg) and an electromagnetic force consisting, at rest, from just the magnetic force of attraction of the magnetized yoke by a magnet on the armature. At rest, the armature closes the yoke.

A coil is wound around one leg of the yoke in such a way that if an electrical current arising from an external event and having to be converted into a mechanical signal flows through it, a repulse magnetic force is added, due to the repulsion of the armature relative to the yoke, which reduces the amplitude of the attractive magnetic force. Thus, depending on the amplitude of the electrical current in the coil, the repulsive force may achieve a level sufficient for the action of the spring to displace it, opening the relay and actuating a mechanical system. It is on this principle that especially electrical circuit breakers operate.

In order for this type of relay to operate with a high sensitivity, it is necessary for a small variation in current I through the coil to cause a large variation in the repulsive force and it is also necessary for this behaviour to be proportional over a sufficiently extensive current range so as to allow suitable presetting of the relay. This amounts to defining a high permeability requirement within quite a linear B—H induction range centred on the operating point of the relay at rest, which corresponds to the magnetization of the relay polarized by the magnet, for a given actuation frequency.

The higher the saturation induction Bs of the material, the higher the variation in induction in the yoke under the effect of the current I and the higher the sensitivity of the relay and its power higher at a given dynamic permeability. There is also a need to have a saturation induction Bₛ at 20° C. of greater than 10000 G and preferably greater than 13000 G and a good magnetization dynamic range obtained by a higher electrical resistivity ρₑₗ of greater than 60 μΩ.cm and preferably greater than 70 μΩ.cm and a low coercive field H_{c} (at 20° C.) of less than 125 mOe and preferably less than 75 mOe.

Moreover, a minimum corrosion resistance is required since the relays are often protected by unsealed packages, letting into them the surrounding atmosphere, which may be potentially hot, wet or oxidizing (Cl, S, etc.) whereas the non-oxidized state of the metal during its operation over several years is important for guaranteeing reproducibility of the tripping conditions by there being no drift in its magnetic performance. It is necessary for I^{ox}ₘₐₓ to remain less than 5 mA and preferably less than 3 mA, or even less than 1 mA.

### Devices for Contactless Temperature Measurement and Temperature-Violation Detection

In another preferred embodiment, the alloy may furthermore be such that:

Cu≦10%

0.02≦Mn

C≦0.1

Eq2≧0.4

Eq3≧140

Eq4≦10

Eq5≦13.6

Eq6≧140

Eq7≧125.

This composition is more particularly suitable for the manufacture of devices for contactless temperature measurement or temperature-violation detection.

The magnetic parts of labels for contactless temperature measurement (measurement in real time using a reversible magnetic phenomenon) or for contactless temperature violation measurement (measurement a postériori using an irreversible phenomenon, but enabling the label at the end of the monitoring process to be reset) use, at the same time, materials that are very different, such as magnetically soft materials (“the alloy”) and permanent magnetization (PM) magnetic materials in a configuration which is stabilized in terms of temperature and surrounding magnetic fields. This temperature monitoring is, through the very principle of the label, performed in the temperature range immediately below and around the Curie point of the soft magnetic alloy.

In this application, it is possible for example to use a plate of PM material of cross section S₁ joined to a plate of material of very high permeability with a cross section S₂, such as a thin FeNi alloy or an amorphous alloy, leaving a small gap d between the two materials. The PM material acts as magnetic polarizer of the adjacent soft magnetic material. In addition, a third plate made of an alloy according to the invention having a Curie point T_{c} is placed either on the other side of the PM material or else between the PM material and the high-permeability material, but separated therefrom by the gap d.

When the ambient temperature approaches the Curie point T_{c} of the alloy according to the invention, it is less magnetized and the magnetic flux of the PM material closes up substantially more onto the high-permeability material which is polarized to an increasing level of magnetization dependent on the T/T_{c} ratio.

By therefore exciting the high-permeability material with a moderate-frequency field from a remote antenna, a change in magnetization ΔJ is produced around the polarization magnetization J₁ and the material will emit harmonics strongly, since J₁ has been optimized beforehand for this purpose, via the choice of S₁, S₂ and d.

The functional Curie point, which it is desired to be between −50° C. and 400° C., and in particular between −30° C. and +100° C. in the case of many applications for monitoring the temperature of consumable products, such as refrigeration systems, wine cellar temperatures, storage and transportation of perishable foodstuffs, whether or not refrigerated, fish and meat containers, blood products and blood derivatives, or the storage and shipping of non-consumable thermally perishable organic substances, such as plants, flowers, human organs removed for transplants or the like, cell cultures and germ or bacteria cultures, batches of polymers, macromolecules, etc. This Curie point is limited to 400° C. at most and is preferably between −30° C. and 100° C.

A sufficiently low coercive field (<75 mOe and preferably <32.5 mOe) is sought so as to obtain, on the one hand, a high sensitivity of the sensor to the excitation field at moderate frequency and, on the other hand, a large dynamic range of the sensor by combining a high electrical resistivity (>60 μΩ.cm and preferably >80 μΩ.cm) with preferably a small material thickness. This restriction to low coercive fields requires the copper content to be limited to 10% at most and preferably to less than 6% together with a maximum nickel content of 34%.

The aim is also to have a minimum corrosion and oxidation resistance since the alloys are often in contact with various media and/or constituents in industrial atmospheres. In these applications, there is often a requirement for good chemical stability of the alloy manifested by good aqueous corrosion resistance (Iₒₓ<5 mA), good salt-fog corrosion resistance and good mechanical stability (adhesion+wear resistance) of the oxidized surface layer in a hot oxidizing atmosphere.

The alloys according to the invention make it possible to achieve all these properties.

Hypertextured Substrates for Epitaxy

In another preferred embodiment, the alloy may furthermore be such that:

Mn≦2%

Si≦1%

Cu≦10%

Cr+Mo≦18%

C≦0.1

Ti+Al≦0.5%,

the alloy furthermore satisfying at least one of the following relationships:

0.0003≦B≦0.004%

0.0003≦S+Se+Sb≦0.008%.

Furthermore, it is preferable to add 0.003 to 0.5% niobium and/or zirconium.

These compositions are more particularly suitable for the manufacture of hypertextured substrates for epitaxy.

Many applications require the growth of thin films of polycrystalline materials that are as textured as possible, i.e. materials with if possible the most accentuated single-component texture as possible.

The term “single-component texture” is understood to mean a non-random distribution of the crystallographic orientations of the polycrystal in such a way that they all lie within a solid angle (with a cone half-angle ω) surrounding the intended ideal orientation, denoted by [hkl](uvw) in Miller indices. ω is called the average texture misorientation angle and may take various values depending on whether the measurement is in the rolling plane or out of said plane.

These deposited materials have particular physical properties such as, for example, superconductivity in the case of Y—Ba—Cu—O-type oxides.

These properties are very greatly improved by there being low defect densities at the grain boundaries, which arise through low misorientation angles between adjacent crystals (the role of an accentuated texture) and through a grain size of the order of a few tens of microns in order to reduce the volume density of defects for the same texture misorientation angle.

To obtain these highly textured polycrystalline coatings, one of the methods very often used is vapour phase epitaxy or liquid phase epitaxy on a substrate which is itself hypertextured with a lattice parameter quite close to that of the product deposited, as accentuated a single-component texture as possible, good oxidation resistance during possible oxidizing annealing operations necessitated by the formation of deposited oxides, and a minimum mechanical strength so as to not to creep during annealing and so as to withstand the processing (coiling, winding, tensioning, etc.) of the final product.

The required specific usage properties of hypertextured substrates are therefore essentially the presence of a surface fraction of twins and other orientations different from the orientations centred with less than a 15° misorientation from the ideal [100](001) cubic orientation, preferably with less than 10% and preferably less than 5%, and also a misorientation angle ω from the main component of the {100}<001> cubic texture of less than 10° and preferably less than 7°.

It is also desirable to have an average expansion coefficient between 20° C. and 100° C. and average expansion coefficient between 20° C. and 300° C. which can vary depending on the final applications. There may thus be a requirement, during deposition on a substrate carried out hot, for the deposited film to be in compression when the product returns to ambient temperature. It is therefore necessary to be able to choose an expansion coefficient which is adjusted, between 20° C. and the deposition temperature, to a very variable level depending on the expansion/contraction of the deposited material.

Finally, the Curie point is not limited for this property, and in certain superconductor applications it is even preferable by far for the substrate to be as little magnetic as possible at the use temperature, i.e. 77 K.

### EXAMPLES

In the context of the present invention, the following abbreviations are used:
Inv.: trial according to the invention;
Comp.: comparative trial;
NCO: trial not carried out;
SFC: sensitivity to salt fog corrosion;
MW: resistance to mechanical wear of the oxidized surface layer of alloys in an oxidizing industrial atmosphere;
Bₛ^{20° C.}: saturation induction measured at 20° C. and expressed in gauss;
Bₛ^{60° C.}(G): saturation induction measured at 60° C. and expressed in gauss;
T_{c}: Curie point of the material, expressed in ° C.;
H_{c}: coercive field at 20° C., measured in mOe;
I^{ox}: maximum imposed-potential current, measured in mA;
Bᵣ/Bₘ: ratio of the remanent induction Bᵣ to the measured induction
Bₘ in the saturation approach zone;
α₂₀₋₁₀₀: average expansion coefficient (also called “expandability”) of the material, measured between 20 and 100° C. and expressed in 10⁻⁶/° C., and α₂₀₋₃₀₀: average expansion coefficient of the material, measured between 20 and 300° C. and expressed in 10⁻⁶/° C., and α_{20-77K}: average expansion coefficient of the material, measured between 77 K and 20° C. and expressed in 10⁻⁶/° C.;
ρₑₗ or ρ(elec): electrical resistivity at 20° C., measured in μΩ.cm
μₘₐₓ^{DC}: maximum relative DC permeability, measured by comparison with the permeability μ₀ (=4π×10⁻⁷) of free space therefore dimensionless, i.e. having no units; and
ω: average texture misorientation angle, measured in ° (degrees).

### Tests and Measurements

To test the alloys according to the invention, various alloy compositions were produced, by vacuum induction melting, in the form of 50 kg ingots with the desired composition. The material was then forged between 1000 and 1200° C., hot-rolled between 1150 and 800° C. down to a thickness of 4.5 mm, chemically pickled and then cold rolled without intermediate annealing down to 0.6 mm. All the alloys were at least characterized at this stage after being cut into various specimens, such as those for expansion coefficient, T_{c}, I^{ox}ₘₐₓ, and Jₛ measurements and washers 25×36 mm in diameter.

Different tests were then carried out.

### Salt-Fog Corrosion Resistance or SFC

To measure the SFC, a sheet of alloy is immersed in a salt-fog environmental chamber with an atmosphere having a 95% relative humidity and saturated with salt (NaCl) for 24 h. The sheets are then rinsed with alcohol and then any corrosion pitting is observed. The density and magnitude of the pickling is then rated in terms of three sensitivity levels:

0: not sensitive;

−: slightly sensitive;

−−: sensitive; and

−−−: very sensitive to salt-fog corrosion.

### Mechanical Wear or MW of the Surface Oxide Layer

To measure the MW, a 0.6 mm thick wet-hardened metal is firstly annealed at a temperature of 1100° C. for 3 h in pure hydrogen and water vapour such that the dew point is −30° C. (simulation of industrial annealing). Two sheets thus annealed are then stacked beneath a uniformly distributed weight, giving a pressure equivalent to 1 kg over an area of 10 cm². 100 to-and-fro sliding movements are then carried out up to mid-length of one sheet relative to the other, and then the wear of the surfaces is observed with three levels of wear resistance after surface examination of the metal:
0: low wear resistance;
+: average mechanical wear resistance; and
++: very good mechanical wear resistance.

### Curie Point T_{c}

T_{c} is measured by measuring the magnetic force using a Chevenard thermomagnetometer: the specimen is heated at 100° C./h up to 800° C. and then cooled at the same rate down to room temperature. The T_{c} value adopted is that corresponding to the use of the thermogram in heating mode—the value T_{c} is extrapolated onto the x-axis (deviation=0) from the tangent to the point of inflection of the magnetic force curve: f (T^{re}).

### Aqueous Acid Corrosion Resistance I^{ox}ₘₐₓ

The corrosion resistance of the alloys in corrosive atmospheres or in aqueous acid media may be determined by measuring the maximum current obtained when an alloy plate specimen is immersed in a 0.01M sulphuric acid bath, the alloy being connected via a conductor to another plate electrode, made of platinum, by applying various voltages U. Various currents I are thus measured on the conductor connecting the two electrodes and the maximum value I^{ox}ₘₐₓ of I (U) is then determined.

Through this test with an imposed potential between plates, the change in the current in the conductor and in particular its maximum value gives a correct determination of the capability of the alloy to form a stable oxide layer on its surface: the lower I^{ox}ₘₐₓ, the better the corrosion resistance of the alloy.

### Expansion Coefficients

The average thermal expansion coefficients are between 20° C. and a temperature T, denoted by <α_{20→T}> or for convenience α_{20-T}—are measured on a Chevenard dilatometer by comparison with a standard Pyros specimen (made of Fe—Ni with a precise composition and precise expansion): the variation in extension Δl of a specimen with an initial length l₀ as a function of the temperature T, namely Δl=f(T) is recorded. The average expansion coefficient between 20° C. and the temperature T₁ is given by:

$$< {α}_{20 \to T 1} >= \frac{1}{{( {T}_{1} - 20 )}^{2}} {\int }_{0}^{{T}_{1}} \frac{Δ l ( T )}{{l}_{0}} \cdot d T$$

expressed in 10⁻⁶/° C. (a millionth of relative elongation per degree).
Magnetic Properties H_{c}, Bᵣ and μₘₐₓ^{DC}

These properties are measured by a fluxmeter method according to the IEC 404-6 standard on annealed washers: by plotting the hysteresis cycle it is possible to determine the values of H_{c}, Bᵣ and μₘₐₓ^{DC}.

### Example 1

### Magnetic Devices with Temperature Self-Regulation

Several alloys were produced and obtained with a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled from the hot-rolled thickness down to a thickness of 0.6 mm, then annealed between 800 and 1100° C. for one hour, then degreased and cut into various pieces or washers for measurements, and then annealed at 1100° C. for 3 h in purified H₂ (dew point <−70° C.).

The grades tested contained the elements mentioned in the following table, the balance being iron and the inevitable impurities.

TABLE 1
Composition of the grades for the trials

| | Grade | % Ni | % Cr | % Cu | % Mn | % Si |
|---|---|---|---|---|---|---|
| Inv. | SV285mod-1 | 32.45 | 0.04 | 0.53 | 0.3 | 0.18 |
| Inv. | SV285mod-6 | 32.45 | 0.04 | 6 | 0.3 | 0.23 |
| Inv. | SV287-1 | 31.8 | 0.04 | 0.5 | 0.3 | 0.34 |
| Inv. | SV287-5 | 30.7 | 0.04 | 3.7 | 0.3 | 0.26 |
| Inv. | SV302mod-1 | 30 | 0.05 | 7 | 0.2 | 0.34 |
| Inv. | SV302mod-2 | 29.4 | 0.05 | 7 | 2 | 0.23 |
| Inv. | SV302mod-3 | 28.8 | 0.05 | 7 | 4 | 0.31 |
| Inv. | SV298-1 | 29.44 | 0.98 | 0.5 | 0.2 | 0.18 |
| Inv. | SV298-4 | 28.9 | 0.97 | 3 | 0.2 | 0.23 |
| Inv. | SV315-3 | 32.5 | 1.97 | 2 | 0.2 | 0.21 |
| Inv. | SV317-1 | 35 | 2 | 0.5 | 0.2 | 0.31 |
| Inv. | SV323-6 | 33 | 1.9 | 0.6 | 3.8 | 0.18 |
| Inv. | SV300-2 | 27.9 | 4 | 1 | 0.2 | 0.31 |
| Comp. | A | 28.9 | 0.03 | 0.15 | 0.2 | 0.31 |
| Comp. | SV297-1 | 26.9 | 1.9 | 1 | 0.2 | 0.34 |
| Comp. | SV300-1 | 28 | 4 | 0.5 | 0.2 | 0.23 |
| Comp. | SV305-1 | 28 | 6 | 0.5 | 0.2 | 0.18 |
| Comp. | Fe—30Ni | 30 | 0 | 0 | 0 | 0 |
| Comp. | B | 27 | 0.03 | 0.14 | 0.2 | 0.23 |
| Comp. | C | 28 | 0.03 | 0.12 | 0.2 | 0.21 |
| Comp. | D | 26.5 | 6 | 0.15 | 0.2 | 0.18 |
| Comp. | E | 26.33 | 4 | 0.12 | 0.2 | 0.17 |

A series of tests was carried out in order to determine the salt-tog corrosion resistance, the mechanical wear resistance, the saturation induction, the Curie point, the acid corrosion resistance and the expansion coefficient between 20 and 100° C.

The results of these tests are given in Table 2.

This shows that some of the alloys according to the invention contain less than 30% Ni and may have a Curie point very close to that of Invar® (Fe-36% Ni: T_{c}=250° C.) such as for example SV302mod-1 (T_{c}=199° C.). The cost of the alloy is therefore substantially reduced by substituting some of the nickel with copper. Furthermore, the aqueous corrosion resistance, the salt-fog corrosion resistance and the oxidation resistance are improved by combined additions of Cu, Si and Cr.

In comparison, if no copper is put into the 30% Ni alloy, a Curie point as low as 40° C. and a very poor acid corrosion resistance are obtained.

TABLE 2
Results of the trials

| | | | | Bₛ^{20°} ^{C.} | T_{c} | I^{ox} | a₂₀₋₁₀₀ |
|---|---|---|---|---|---|---|---|
| | Grade | SFC | MW | (G) | (° C.) | (mA) | (10⁻⁶/° C.) |
| Inv. | SV285mod-1 | − | ++ | 9560 | 205 | 4.5 | 4.2 |
| Inv. | SV285mod-6 | − | ++ | 12410 | 238 | 3.9 | 3.05 |
| Inv. | SV287-1 | − | ++ | 8420 | 152 | 4.5 | 5.3 |
| Inv. | SV287-5 | − | ++ | 9780 | 198 | 4.04 | 4.1 |
| Inv. | SV302mod-1 | − | ++ | 9820 | 199 | 4.5 | 4.8 |
| Inv. | SV302mod-2 | − | ++ | 7580 | 154 | 4.6 | 6.3 |
| Inv. | SV302mod-3 | − | ++ | 5210 | 104 | 4.6 | 7.8 |
| Inv. | SV298-1 | − | ++ | 5030 | 104 | 2.9 | 11 |
| Inv. | SV298-4 | − | ++ | 6810 | 137 | 2.8 | 8.3 |
| Inv. | SV315-3 | − | ++ | 9520 | 174 | 1.3 | 4.5 |
| Inv. | SV317-1 | − | ++ | 11100 | 204 | 1.5 | 2.4 |
| Inv. | SV323-6 | − | ++ | 4400 | 78 | 1.6 | 4.5 |
| Inv. | SV300-2 | − | ++ | 1970 | 37 | 1.9 | NCO |
| Comp. | A | − | ++ | 1650 | 25 | 4.5 | NCO |
| Comp. | SV297-1 | − | ++ | 1530 | 24 | 2.6 | NCO |
| Comp. | SV300-1 | − | ++ | 1570 | 24 | 1.7 | NCO |
| Comp. | SV305-1 | − | ++ | 1140 | 18 | 1.4 | NCO |
| Comp. | Fe—30Ni | −− | −− | 120 | 40 | 7 | NCO |
| Comp. | B | − | ++ | 0 | −50 | 4.9 | NCO |
| Comp. | C | − | ++ | 0 | −10 | 4.7 | NCO |
| Comp. | D | − | ++ | 0 | −50 | 3.1 | NCO |
| Comp. | E | − | ++ | 0 | −50 | 3.7 | NCO |

It may also be seen in the example SV298-1 that a high expansion coefficient between 20 and 100° C. may be obtained (11×10⁻⁶/° C. in the example) by suitably adjusting the Ni, Cr and Cu contents and without exceeding 30% Ni. The choice of composition sets at the same time the Curie point.

### Example 2

### Devices with Magnetic Flux Self-Regulation

Several alloys were produced and obtained with a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled from the hot-rolled thickness down to a thickness of 0.6 mm, then annealed between 800 and 1100° C. for one hour, then degreased and cut into various pieces or washers for measurements, and then annealed at 1100° C. for 3 h in purified H₂ (dew point <−70° C.).

The grades tested contained the elements mentioned in the following table, the balance being iron and the inevitable impurities.

TABLE 3
Composition of the grades for the trials

| | Grade | % Ni | % Cr | % Cu | % Mn | % Si |
|---|---|---|---|---|---|---|
| Inv. | TD521-2 | 28 | 0.02 | 1 | 0.02 | 0.2 |
| Inv. | TD521-3 | 28 | 0.02 | 3 | 0.02 | 0.2 |
| Inv. | TD561-1 | 26 | 2 | 10 | 0.02 | 0.2 |
| Inv. | TD565-1 | 25 | 1 | 10 | 0.02 | 0.2 |
| Inv. | TD558-1 | 28 | 2 | 3 | 0.02 | 0.2 |
| Inv. | SV289-1 | 27.8 | 2 | 1 | 0.02 | 0.2 |
| Inv. | SV297-3 | 26.2 | 1.9 | 4 | 0.02 | 0.2 |
| Comp. | SV302mod-4 | 28.2 | 0.1 | 6 | 6 | 0.3 |
| Comp. | SV297-1 | 26.9 | 1.9 | 1 | 0 | 0.2 |
| Comp. | NMHG-1 | 28 | 0 | 0 | 0 | 0.2 |
| Comp. | NMHG-2 | 29 | 0 | 0 | 0 | 0.2 |

A series of tests was produced in order to determine the salt-fog corrosion resistance, the mechanical wear resistance, the saturation induction, the Curie point, the acid corrosion resistance and the expansion coefficient between 20 and 100° C.

The results of these tests are given in Table 4.

It may be seen that most of the alloys according to the invention have Curie points ranging from 30° C. to about 100° C. for alloys containing only 25 to 28% Ni depending on the desired corrosion resistance and/or oxidation resistance. The SV302mod-4 counter-example cannot be suitable as it contains more than 2% manganese and has a degraded wear resistance of the oxidized layer despite the presence of silicon.

The counter-examples SV297-1, NMHG-1 and NMGH-2 are not according to the invention as they do not satisfy equation 2. It may be seen that their Curie temperatures are below the 30° C. limit value, unlike the examples according to the invention.

TABLE 4
Results of the trials

| | | | | Bₛ^{20° C.} | T_{c} | I^{ox} |
|---|---|---|---|---|---|---|
| | Grade | SFC | MW | (G) | (° C.) | (mA) |
| Inv. | TD521-2 | − | ++ | 4610 | 75 | 3.2 |
| Inv. | TD521-3 | − | ++ | 5420 | 98 | 2.3 |
| Inv. | TD561-1 | − | ++ | 5070 | 100 | 1.1 |
| Inv. | TD565-1 | − | ++ | 4000 | 81 | 1.6 |
| Inv. | TD558-1 | − | ++ | 4900 | 95 | 1.3 |
| Inv. | SV289-1 | − | ++ | 2540 | 43 | 1.7 |
| Inv. | SV297-3 | − | ++ | 3170 | 53 | 1.8 |
| Comp. | SV302mod-4 | − | + | 3450 | 67 | 4.7 |
| Comp. | SV297-1 | − | ++ | 1530 | 24 | 2.5 |
| Comp. | NMHG-1 | NCO | NCO | NCO | −10 | NCO |
| Comp. | NMHG-2 | NCO | NCO | NCO | 25 | NCO |

### Example 3

### Controlled Expansion Devices

Several alloys were produced and obtained with a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled from the hot-rolled thickness down to a thickness of 0.6 mm, then annealed between 800 and 1100° C. for one hour, then degreased and cut into various pieces or washers for measurements, and then annealed at 1100° C. for 3 h in purified H₂ (dew point <−70° C.).

The expansion coefficient measurements were taken on a Chevenard dilatometer between −196° C. and 800° C.

The grades tested contained the elements mentioned in the following table, the balance being iron and the inevitable impurities.

TABLE 5
Composition of the grades for the trials

| | Grade | % Ni | % Cr | % Cu | % Mn | % Si |
|---|---|---|---|---|---|---|
| Inv. | 36 | 32.45 | 0.04 | 4 | 0.3 | 0.17 |
| Comp. | Invar ® | 36 | 0 | 0 | 0.2 | 0.05 |
| Inv. | SV285mod-1 | 32.45 | 0.04 | 0.53 | 0.3 | 0.18 |
| Inv. | SV285mod-2 | 32.45 | 0.04 | 1 | 0.3 | 0.17 |
| Inv. | SV287mod3 | 31.3 | 0.04 | 1.9 | 0.3 | 0.16 |
| Inv. | SV287mod4 | 31 | 0.04 | 2.8 | 0.3 | 0.22 |
| Inv. | SV287mod5 | 30.7 | 0.04 | 3.7 | 0.3 | 0.23 |
| Inv. | SV287mod6 | 30.2 | 0.04 | 5.5 | 0.3 | 0.19 |
| Inv. | SV315-5 | 31.9 | 1.93 | 4 | 0.2 | 0.18 |
| Inv. | SV318-6 | 34.1 | 1.89 | 6 | 0.2 | 0.23 |
| Comp. | N42 | 42 | 0 | 0 | 0.2 | 0.07 |
| Inv. | SV304-4 | 28.2 | 2 | 7 | 6 | 0.17 |
| Inv. | TD561-3 | 28 | 2 | 10 | 0.3 | 0.21 |
| Comp. | N426 | 42 | 6 | 0 | 0.25 | 0.22 |
| Inv. | SV296-4 | 28.2 | 1.9 | 3 | 0.2 | 0.19 |
| Inv. | TD521-4 | 28 | 0.03 | 6 | 0.2 | 0.2 |
| Inv. | TD561-1 | 26 | 2 | 10 | 0.3 | 0.22 |
| Comp. | N485 | 48 | 6 | 0 | 0.33 | 0.06 |
| Inv. | TD558-6 | 31 | 2 | 3 | 0.24 | 0.15 |
| Inv. | TD558-7 | 32 | 2 | 3 | 0.22 | 0.12 |
| Inv. | TD558-8 | 33 | 2 | 3 | 0.21 | 0.17 |
| Inv. | TD560-3 | 30 | 0.05 | 10 | 0.26 | 0.15 |
| Inv. | TD563-6 | 31 | 1.5 | 3 | 0.22 | 0.16 |
| Comp. | Invar M93 | 36 | 0 | 0 | 0.2 | 0.03 |

A series of tests was carried out in order to determine the salt-fog corrosion resistance, the mechanical wear resistance, the Curie point, the acid corrosion resistance and the expansion coefficient between 20 and 100° C. and between 20 and 300° C.

The results of these tests are given in Table 6.

The first two trials correspond to very low expansion coefficients. The following nine trials have expansion coefficients close to semiconductors such as Si, Ge, GaAs and SiC. The next seven have expansion coefficients close to those of glasses. The next six are compatible with the use as a gastight container for transporting liquefied gas at 77 K in the holds of LNG (liquefied natural gas) tankers.

TABLE 6
Results of the trials

| | | | | α₂₀₋₁₀₀ | α₂₀₋₃₀₀ | α_{20-77K} | I^{ox}ₘₐₓ |
|---|---|---|---|---|---|---|---|
| | Grade | SFC | MW | (10⁻⁶/° C.) | (10⁻⁶/° C.) | (10⁻⁶/° C.) | (mA) |
| Inv. | 36 | − | ++ | 2.7 | NCO | NCO | 3.9 |
| Comp. | Invar ® | −− | 0 | 1.5 | 3 | NCO | 6.2 |
| Inv. | SV285mod-1 | − | ++ | 4.2 | 10 | NCO | 4.5 |
| Inv. | SV285mod-2 | − | ++ | 3.9 | 9.6 | NCO | 4.4 |
| Inv. | SV287mod3 | − | ++ | 4.5 | 10 | NCO | 4.17 |
| Inv. | SV287mod4 | − | ++ | 4.03 | 9.6 | NCO | 4.4 |
| Inv. | SV287mod5 | − | ++ | 4.1 | 9.4 | NCO | 4.04 |
| Inv. | SV287mod6 | − | ++ | 4.19 | 9.1 | NCO | 3.95 |
| Inv. | SV315-5 | − | ++ | 4.6 | 9.3 | NCO | 1.1 |
| Inv. | SV318-6 | 0 | ++ | 4.4 | 6 | NCO | 1.2 |
| Comp. | N42 | −− | 0 | 4 | 4.3 | NCO | 5.7 |
| Inv. | SV304-4 | − | ++ | 7.1 | 11.9 | NCO | 1.02 |
| Inv. | TD561-3 | − | ++ | 6.7 | 11.6 | NCO | 0.9 |
| Comp | N426 | 0 | + | 8.3 | NCO | NCO | NCO |
| Inv. | SV296-4 | −− | ++ | 8.5 | 13.4 | NCO | 4.2 |
| Inv. | TD521-4 | − | ++ | 9.6 | 11.9 | NCO | 2.1 |
| Inv. | TD561-1 | − | ++ | 9.5 | 14.1 | NCO | 0.7 |
| Comp. | N485 | 0 | + | 9.2 | 9.3 | NCO | NCO |
| Inv. | TD558-6 | − | ++ | 5.79 | 11.19 | 3.5 | 1.9 |
| Inv. | TD558-7 | − | ++ | 4.58 | 9.75 | 3.05 | 1.7 |
| Inv. | TD558-8 | − | ++ | 3.78 | 8.42 | 3 | 1.6 |
| Inv. | TD560-3 | − | ++ | 3.99 | 7.94 | 3.68 | 3.3 |
| Inv. | TD563-6 | − | ++ | 5.09 | 10.8 | 3.23 | 2.6 |
| Comp. | Invar M93 | − | + | <2 | NCO | <2 | NCO |

In example 36, compared with Invar®, it is apparent that substituting 3.5% Ni with 4% Cu and small contents of Si and Cr makes it possible to maintain an expansion coefficient of less than 3×10⁻⁶/° C. between 20 and 100° C., which is sufficient for many applications requiring both the cost and the expansion around room temperature to be limited, such as shadow masks of high-definition cathode-ray tube screens, piezoelectric fuel injection actuator supports for motor vehicles, bulk moulds for aeronautical parts made of carbon fibre and the like, and also requiring the materials to oxidize little in industrial annealing in a very slightly reducing atmosphere or even in an oxidizing atmosphere, and makes it possible to dispense with the use of a protective gas atmosphere, thus simplifying the industrial processing.

In example SV318-6 in comparison with N42, it is apparent that substituting 8% Ni with 6% Cu and 2% Cr and a small amount of Si makes it possible to maintain an expansion coefficient not exceeding 6×10⁻⁶/° C. between 20 and 300° C. and even an equivalent expansion coefficient between 20 and 100° C., this being sufficient for most applications requiring both the cost and the expansion upon contact with semiconductor materials in a restricted temperature range from 100 to 300° C. above the ambient temperature, such as integrated circuit supports, to be limited.

In the examples SV304-4 and TD561-3 of this table compared with N426 used for its expansion compatibility with glasses of the lead-soda glass type, it is apparent that substituting 14% Ni with 7 to 10% Cu and small amounts of Si and Cr makes it possible to maintain an expansion coefficient of around 7×10⁻⁶/° C. between 20 and 100° C. and 11.5×10⁻⁶/° C. between 20 and 300° C., this being sufficient for many applications requiring both the cost and the expansion upon contact with certain glasses, alumina, beryllium oxide, certain semiconductors, such as GaAs, etc. to be limited within a restricted temperature range of 100 to 300° C. above room temperature.

In example TD521-4 of this table, compared with N485, it is apparent that substituting 20% Ni with 6% Cu and less than 2% Cr and a small amount of Si makes it possible to maintain an expansion coefficient of around 9.5×10⁻⁶/° C. between 20 and 100° C. and 11.9×10⁻⁶/° C. between 20 and 300° C., this being sufficient for many applications requiring both the cost and the expansion upon contact with these highly expandable glasses, ZrO₂, forsterite, etc. to be limited within a restricted temperature range of 100 to 300° C. above room temperature.

In LNG tankers, there is a requirement to have a very low expansion coefficient between −196° C. (nitrogen gas liquefaction temperature) and the ambient temperature so that the enormous liquefied gas containers can withstand the destructive expansion forces, in particular at the triple weld joints of the containers. In the last examples of the table, it may be seen that substituting 3 to 6% Ni with 3 to 10% Cu and small amounts of Si and Cr makes it possible to maintain an expansion coefficient of around 3 to 3.5×10⁻⁶/° C. between −196° C. and 20° C., this being sufficient for this application requiring both the cost and the expansion of the superstructure between the liquefied gas at −196° C. on one side and the ambient temperature on the other side to be limited.

### Example 4

### Current Sensors and Measurement Transformers

Several alloys were produced with a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled without intermediate annealing from the hot-rolled thickness down to a thickness of 0.6 mm and then cut into various pieces or washers for measurements (see above for the various types of characterization used) before being degreased and then annealed at 1100° C. for 3 hours in purified H₂ (dew point <−70° C.).

The grades tested contained the elements mentioned in the following table, the balance being iron and the inevitable impurities.

TABLE 7
Composition of the grades for the trials

| | Grade | % Ni | % Cr | % Cu | % Mn | % Si |
|---|---|---|---|---|---|---|
| Inv. | TC768/SP302+ | 30 | 2 | 3 | 0.3 | 0.16 |
| Inv. | SV304-2 | 29.4 | 2 | 7 | 2 | 0.19 |
| Inv. | SV314-6 | 30.3 | 1.89 | 6 | 0.2 | 0.17 |
| Inv. | SV318-6 | 34.1 | 1.89 | 6 | 0.2 | 0.16 |
| Inv. | SV290-4 | 28.2 | 2 | 3 | 0.3 | 0.16 |
| Inv. | SV296-2 | 29.2 | 1.9 | 1 | 0.2 | 0.17 |
| Inv. | SV316-4 | 33.2 | 1.95 | 3 | 0.2 | 0.18 |
| Inv. | SV317-5 | 33.8 | 1.93 | 4 | 0.2 | 0.17 |
| Inv. | SV302mod-3 | 28.8 | 0.05 | 7 | 4 | 0.17 |
| Inv. | SV298-3 | 29.1 | 0.97 | 2 | 0.2 | 0.19 |
| Inv. | SV330-4 | 27.5 | 0.03 | 3 | 0.2 | 0.18 |
| Inv. | SV330-6 | 27.5 | 0.03 | 7 | 0.2 | 0.17 |
| Inv. | SV333-2 | 29 | 0.03 | 1 | 0.2 | 0.16 |
| Inv. | SV333-5 | 29 | 0.03 | 5 | 0.2 | 0.17 |
| Inv. | SV339-2 | 29 | 0.2 | 1 | 0.2 | 0.19 |
| Inv. | SV339-5 | 29 | 0.2 | 5 | 0.2 | 0.17 |
| Comp. | SV330-8 | 27.5 | 0.03 | 13 | 0.2 | 0.18 |
| Comp. | SV333-8 | 29 | 0.03 | 13 | 0.2 | 0.18 |
| Comp. | SV339-8 | 29 | 0.2 | 13 | 0.2 | 0.15 |

A series of tests was carried out in order to determine the salt-fog corrosion resistance, the mechanical wear resistance, the saturation induction at 20° C., the rectangularity of the hysteresis cycle at 20° C., the coercive field at 20° C., the electrical resistivity at 20° C. and the acid corrosion resistance.

The results of these tests are given in Table 8.

TABLE 8
Results of the trials

| | | | | Bₛ^{20°} ^{C.} | | H_{c} | ρ-elec | I^{ox} |
|---|---|---|---|---|---|---|---|---|
| | Grade | SFC | MW | (G) | Bᵣ/Bₘ | (mOe) | (μΩ · cm) | (mA) |
| Inv. | TC768/SP302+ | − | ++ | 7380 | NCO | 41 | 88.6 | 1.3 |
| Inv. | SV304-2 | 0 | ++ | 6310 | 0.32 | 32 | 85 | 0.9 |
| Inv. | SV314-6 | 0 | ++ | 9190 | 0.33 | 34 | 86 | 1.2 |
| Inv. | SV318-6 | 0 | ++ | 11960 | 0.34 | 31 | 82 | 1.2 |
| Inv. | SV290-4 | 0 | ++ | 5180 | 0.41 | 25 | 87 | 4.2 |
| Inv. | SV296-2 | 0 | ++ | 5560 | 0.47 | 30 | 87.5 | 4.1 |
| Inv. | SV316-4 | 0 | ++ | 10620 | 0.34 | 37 | 87 | 1.3 |
| Inv. | SV317-5 | 0 | ++ | 11540 | 0.35 | 34 | 86.5 | 1.1 |
| Inv. | SV302mod-3 | 0 | ++ | 5210 | 0.32 | 21 | 75 | 4.6 |
| Inv. | SV298-3 | 0 | ++ | 6170 | 0.43 | 32 | 87 | 2.8 |
| Inv. | SV330-4 | − | ++ | 4430 | NCO | 19 | 87 | 4.9 |
| Inv. | SV330-6 | − | ++ | 6800 | NCO | 33 | 88 | 4.7 |
| Inv. | SV333-2 | − | ++ | 4250 | NCO | 18 | 85 | 4.6 |
| Inv. | SV333-5 | − | ++ | 8360 | NCO | 43 | 90 | 4.4 |
| Inv. | SV339-2 | − | ++ | 4300 | NCO | 20 | 85 | 3.7 |
| Inv. | SV339-5 | − | ++ | 8430 | NCO | 40 | 90 | 3.4 |
| Comp. | SV330-8 | − | ++ | 8340 | NCO | 270 | 76 | 4.4 |
| Comp. | SV333-8 | − | ++ | 9970 | NCO | 330 | 78 | 4.2 |
| Comp. | SV339-8 | − | ++ | 10070 | NCO | 364 | 78 | 3.1 |

This table shows that the alloys containing more than 10% Cu have very high coercive fields ranging from 200 to 400 mOe that are incompatible with an application of the measurement transformer type.

Alloy SV330-4 is particularly inexpensive, containing 28% Ni and 3% Cu with a very low H_{c} of 19 mOe allowing very high precision of the measurement transformer. However, its low saturation (4430 G) restricts it to applications around room temperature.

In another example of the invention, the alloy SV330-6 is almost as inexpensive, containing 28% Ni and 7% Cu and allowing good precision of a closed-loop current sensor thanks to H_{c}=33 mOe. In addition, its higher saturation (6800 G) makes it markedly more temperature stable and allows the measurement transformer to be operated up to 70° C.

In a final example, alloy SV317-5 having a high saturation (11540 G) and a low coercive field (34 mOe) enables a high-precision open-loop current sensor to be produced inexpensively (containing 34% Ni) whilst still guaranteeing good corrosion resistance in many media thanks to a combination of 2% Cr and 4% Cu combined with silicon.

### Example 5

### Magneto-Harmonic Sensors

Several alloys were produced and obtained with a final thickness of 0.04 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled from the hot-rolled thickness down to a thickness of 0.6 mm, then annealed between 800 and 1100° C. for one hour, then rolled down to a final thickness of 40 μm, then degreased and cut into various pieces or washers for measurements, and then annealed at 1100° C. for 3 h in purified H₂ (dew point <−70° C.).

The grades tested contained the elements mentioned in the following table, the balance being iron and the inevitable impurities.

TABLE 9
Composition of the grades for the trials

| | Grade | % Ni | % Cr | % Cu | % Mn | % Si |
|---|---|---|---|---|---|---|
| Inv. | SV292-3 | 29.9 | 0.5 | 0.5 | 0.3 | 0.22 |
| Inv. | SV323-6 | 33 | 1.9 | 0.6 | 3.8 | 0.23 |
| Inv. | SV289-3 | 27 | 1.99 | 3.85 | 0.3 | 0.25 |
| Inv. | SV290-3 | 28.4 | 2 | 2 | 0.3 | 0.23 |
| Inv. | SV296-1 | 29.3 | 1.9 | 0.5 | 0.2 | 0.24 |
| Inv. | SV306-4 | 28.3 | 3.9 | 3 | 0.2 | 0.25 |
| Inv. | SV289-4 | 26.5 | 1.98 | 5.6 | 0.3 | 0.24 |
| Inv. | SV304-3 | 28.8 | 2 | 7 | 4 | 0.24 |

A series of tests was carried out in order to determine the salt-fog corrosion resistance, the mechanical wear resistance, the saturation induction at 20° C., the coercive field at 20° C., the electrical resistivity at 20° C. and the acid corrosion resistance.

The results of these tests are given in Table 10.

TABLE 10
Results of the trials

| | | | | Bₛ^{20° C.} | H_{c} | r (elec) | I^{ox} |
|---|---|---|---|---|---|---|---|
| | Grade | SFC | MW | (G) | (mOe) | (μΩ · cm) | (mA) |
| Inv. | SV292-3 | − | ++ | 4960 | 46 | 84 | 4.3 |
| Inv. | SV323-6 | − | ++ | 4400 | 15 | 84.5 | 1.6 |
| Inv. | SV289-3 | − | ++ | 4470 | 18 | 88.5 | 3.9 |
| Inv. | SV290-3 | − | ++ | 4580 | 19 | 86 | 4.3 |
| Inv. | SV296-1 | − | ++ | 4820 | 23 | 85 | 4.1 |
| Inv. | SV306-4 | 0 | ++ | 4480 | 18 | 88 | 3.6 |
| Inv. | SV289-4 | − | ++ | 4720 | 31 | 87 | 1.1 |
| Inv. | SV304-3 | − | ++ | 4380 | 21 | 86.5 | 0.93 |

Example SV323-6 according to the invention has a greatly improved aqueous corrosion resistance and the sensitivity of the sensor is excellent (H_{c}=15 mOe).

In example SV306-4, the nickel content is lowered to 28%, while the corrosion resistance, salt-fog corrosion resistance and oxidation resistance in a hot oxidizing atmosphere are all excellent, as is the sensitivity of the sensor (H_{c}=18 mOe). This is permitted thanks to optimization of the relative Ni, Cr, Cu, Mn and Si compositions. The cost of the sensor may also be substantially lowered in example SV289-4 containing only 26.5% Ni thanks to a high copper content (5.6%) making it possible to obtain good corrosion resistance, good oxidation resistance and very good sensitivity of the sensor (H_{c}=31 mOe).

### Example 6

### Motors and Electromagnetic Actuators

Several alloys were produced down to a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled without intermediate annealing from the hot-rolled thickness down to a thickness of 0.6 mm, then cut into various parts or washers for measurements before being degreased and then annealed at 1100° C. for 3 hours in purified H₂ (dew point <−70° C.).

The grades tested contained the elements mentioned in the following table, the balance being iron and the inevitable impurities.

TABLE 11
Composition of the grades for the trials

| | | | | | | | % S | % B |
|---|---|---|---|---|---|---|---|---|
| | Grade | % Ni | % Cr | % Cu | % Mn | % Si | (ppm) | (ppm) |
| Inv. | TD560-1 | 28 | 0.04 | 10 | 0.2 | 0.23 | 23 | 4 |
| Inv. | TD560-3 | 30 | 0.04 | 10 | 0.2 | 0.26 | 32 | 0 |
| Inv. | TD560-5 | 32 | 0.04 | 10 | 0.2 | 0.28 | 29 | 0 |
| Inv. | TD560-7 | 34 | 0.04 | 10 | 0.2 | 0.23 | 27 | 0 |
| Inv. | TD560-8 | 35 | 0.04 | 10 | 0.2 | 0.23 | 24 | 5 |
| Inv. | TD561-3 | 28 | 2 | 10 | 0.2 | 0.26 | 28 | 0 |
| Inv. | TD561-5 | 30 | 2 | 10 | 0.2 | 0.26 | 29 | 0 |
| Inv. | TD561-7 | 32 | 2 | 10 | 0.2 | 0.23 | 31 | 7 |
| Inv. | TD565-6 | 34 | 2 | 10 | 0.2 | 0.22 | 33 | 8 |
| Comp. | SV292-4mod | 29 | 0.5 | 0.9 | 0.3 | 0.24 | 16 | 5 |
| Comp. | SV304-2mod | 29.4 | 2 | 7 | 4.5 | 0.24 | 18 | 0 |

A series of tests was carried out in order to determine the salt-fog corrosion resistance, the mechanical wear resistance, the saturation induction at 20° C., the coercive field at 20° C., the electrical resistivity at 20° C. and the acid corrosion resistance.

The results of these tests are given in Table 12.

It may be seen that the salt-fog corrosion sensitivity and mechanical wear resistance properties of the oxidized surface layer are always good provided that the Cr, Si and Cu minima are respected.

TABLE 12
Results of the trials

| | | | | Bₛ^{20° C.} | H_{c} | Br/ | |
|---|---|---|---|---|---|---|---|
| | Grade | SFC | MW | (G) | (mOe) | Bm | μₘₐₓ^{DC} |
| Inv. | TD560-1 | − | ++ | 7950 | 70 | 0.17 | 6000 |
| Inv. | TD560-3 | − | ++ | 10300 | 62 | 0.17 | 8500 |
| Inv. | TD560-5 | − | ++ | 12300 | 55 | 0.17 | 11000 |
| Inv. | TD560-7 | − | ++ | 13300 | 51 | 0.19 | 15000 |
| Inv. | TD560-8 | − | ++ | 13700 | NCO | NCO | 16000 |
| Inv. | TD561-3 | − | ++ | 7000 | 76 | 0.22 | 6000 |
| Inv. | TD561-5 | 0 | ++ | 9200 | 72 | 0.22 | 8500 |
| Inv. | TD561-7 | 0 | ++ | 10700 | 56 | 0.23 | 12500 |
| Inv. | TD565-6 | 0 | ++ | 11800 | 46 | 0.30 | 20500 |
| Comp. | SV292-4mod | − | ++ | 4800 | 55 | NCO | NCO |
| Comp. | SV304-2mod | 0 | ++ | 4080 | 21 | NCO | NCO |

Many alloys with various compositions containing from 28 to 34% nickel make it possible to obtain magnetic saturations ranging from 5000 to 12 000 G and electrical resistivities ranging from 80 to 90 μΩ.cm, while still maintaining low coercive fields and various corrosion resistance values depending on the precise requirement of the application.

As counter-example, alloy SV292-4mod does not satisfy equation 2, resulting in too low a saturation (4800 G) combined with an insufficient percentage content of Cu relative to the nickel content. In another counter-example, alloy SV304-2mod does not comply with the invention since its saturation is much too low (4080 G instead of the minimum of 5000 G), this being due to its excessively high manganese content.

Alloy TD560-8 contains 35% Ni and has a high saturation. Its permeability μmax along the 0°, 45° and 90° directions relative to the rolling direction was measured. The values obtained were 19000, 17200 and 17600 respectively, which shows that the alloy is almost perfectly isotropic thanks to the succession of heavy rolling steps and the final annealing at high temperature. By dint of this property, the magnetic flux which circulates is isotropic and certain directions in the plate will not be preferential, which is frequently the origin of electromagnetic torque fluctuations in electrical machines. The alloys according to the invention therefore also have the property, through the appropriate cold-rolling and annealing steps, of being able to have, if required, good isotropy of the magnetic properties.

It has also been observed that the alloys according to the invention have a low remanance (rectangularity of the hysteresis cycle, Br/Bm <0.3). thereby making it possible either to be naturally demagnetized to a large part as soon as the excitation is removed (natural “defluxing”) or to be insensitive to disturbing parasitic fields (superposed fields or very high transient overcurrents that saturate the material in a very short space of time). In particular, it should be noted that it is advantageous to lower the % nickel content and the % chromium content so as to reduce the Bᵣ/Bₘ rectangularity to very low values, such as 0.17 in the case of alloys TD560-1, 3 and 5 having a minimum % Cr content, 28 to 32% Ni and 10% Cu.

### Example 7

### Stators for Watch Motors

Several alloys were produced down to a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled without intermediate annealing from the hot-rolled thickness down to a thickness of 0.6 mm and then cut into various parts or washers for measurements before being degreased and then annealed at 1100° C. for 3 hours in purified H₂ (dew point <−70° C.).

The grades tested contained the elements mentioned in the following table, the balance being iron and the inevitable impurities.

TABLE 13
Composition of the grades for the trials

| | Grade | % Ni | % Cr | % Co | % Cu | % Mn | % Si | % S | % B | % O + N |
|---|---|---|---|---|---|---|---|---|---|---|
| Inv. | TC767 | 31.7 | 8 | 0.01 | 2.97 | 0.32 | 0.2 | 19 | 0 | 59 |
| Inv. | TD521mod | 28 | 0.03 | 0 | 5.5 | 0.2 | 0.22 | 24 | 0 | 59 |
| Inv. | SV302mod2 | 29.4 | 0.05 | 0 | 7 | 2 | 0.25 | 12 | 0 | 64 |
| Inv. | SV292-5 | 29.2 | 0.5 | 0 | 2.8 | 0.3 | 0.23 | 17 | 0 | 58 |
| Inv. | SV292-6 | 28.6 | 0.5 | 0 | 4.5 | 0.3 | 0.19 | 19 | 4 | 73 |
| Inv. | SV298-4 | 28.9 | 0.97 | 0 | 3 | 0.2 | 0.11 | 36 | 8 | 59 |
| Inv. | SV298-5 | 28.6 | 0.96 | 0 | 4 | 0.2 | 0.22 | 24 | 5 | 67 |
| Inv. | SV296-4 | 28.2 | 1.9 | 0 | 3 | 0.2 | 0.24 | 9 | 7 | 58 |
| Inv. | SV304-2 | 29.4 | 2 | 0 | 7 | 0.2 | 0.23 | 25 | 0 | 48 |
| Inv. | SV316-6 | 32.2 | 1.89 | 0 | 6 | 0.2 | 0.19 | 24 | 0 | 59 |
| Inv. | TD561-3 | 28 | 2 | 0 | 10 | 0.3 | 0.2 | 28 | 0 | 56 |
| Comp. | SV306-6 | 27.4 | 3.8 | 0 | 6 | 0.28 | 0.2 | 25 | 8 | 84 |
| Comp. | TC757 | 31.8 | 8.2 | 3.07 | 0.06 | 0.24 | 0.2 | 23 | 0 | 67 |
| Comp. | SV298-1 | 29.4 | 1 | 0 | 0.5 | 0.43 | 0.2 | 27 | 5 | 61 |
| Comp. | SV288-2 | 29.5 | 1 | 0 | 1 | 0.32 | 0.3 | 25 | 7 | 48 |
| Comp. | SV299-6 | 28.2 | 4.7 | 0 | 2.95 | 0.35 | 0.3 | 23 | 0 | 70 |
| Comp. | SV301-1 | 30 | 0 | 0 | 0.1 | 0.32 | 0.2 | 24 | 0 | 75 |
| Comp. | 22 bis | 30 | 0.1 | 0 | 0.2 | 3.5 | 0.17 | 15 | 5 | 58 |

The Curie point was determined by a round trip of the thermomagnetometer, up to a temperature of 800° C. and back.

A series of tests was also carried out in order to determine the salt-fog corrosion resistance, the mechanical wear resistance, the electrical resistivity at 20° C., the Curie point, the coercive field at 20° C., the saturation induction at 20° C. and the saturation induction at 60° C.

The results of these tests are given in Table 14.

TABLE 14
Results of the trials

| | | | | ρₑₗ | T_{c} | H_{c} | Bₛ^{20° C.} | Bₛ^{60° C.} |
|---|---|---|---|---|---|---|---|---|
| | Grade | SFC | MW | (μΩ · cm) | (° C.) | (mOe) | (G) | (G) |
| Inv. | TD521mod | − | ++ | 85 | 156 | 48 | 7430 | 5500 |
| Inv. | SV302mod2 | − | ++ | 83 | 154 | 44 | 7580 | 5700 |
| Inv. | SV292-5 | − | ++ | 86.5 | 137 | 64 | 6700 | 4300 |
| Inv. | SV292-6 | − | ++ | 86.5 | 154 | 70 | 7530 | 5600 |
| Inv. | SV298-4 | − | ++ | 87.5 | 137 | 38 | 6810 | 4700 |
| Inv. | SV298-5 | − | ++ | 87.5 | 144 | 46 | 7150 | 4900 |
| Inv. | SV296-4 | − | ++ | 86.7 | 112 | 41 | 6310 | 4100 |
| Inv. | SV304-2 | 0 | ++ | 85 | 111 | 32 | 6310 | 4150 |
| Inv. | SV316-6 | 0 | ++ | 85 | 211 | 38 | 10810 | 9500 |
| Inv. | TD561-3 | 0 | ++ | 82 | 131 | 76 | 7450 | 5200 |
| Comp. | SV306-6 | − | ++ | NCO | 93 | NCO | 5060 | NCO |
| Comp. | TC757 | 0 | + | NCO | 95 | NCO | 5470 | 4630 |
| Comp. | SV298-1 | − | ++ | NCO | 92 | NCO | 5030 | NCO |
| Comp. | SV288-2 | − | ++ | NCO | 98 | NCO | 5510 | NCO |
| Comp. | SV299-6 | 0 | ++ | NCO | 80 | NCO | 4520 | NCO |
| Comp. | SV301-1 | −− | ++ | NCO | 76 | NCO | 4300 | NCO |
| Comp. | 22 a | − | ++ | 83 | 76 | 22 | 4300 | 2200 |

### Example 8

### Inductor and Transformer for Power Electronics

Several alloys were produced down to a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled from the hot-rolled thickness down to a thickness of 0.6 mm, then annealed between 800 and 1100° C. for one hour, then degreased, cold-rolled down to a thickness of 0.05 mm, sheared, coated with a mineral insulator, so as to prevent the turns from sticking during annealing and wound as tori having diameters of 30×20 mm and a height of 20 mm, before being annealed at 1100° C. for 3 h in purified H₂ (dew point <−70° C.).

The grades tested contained the elements mentioned in the following table, the balance being iron and the inevitable impurities.

TABLE 15
Composition of the grades for the trials

| | Grade | % Ni | % Cr | % Cu | % Mn |
|---|---|---|---|---|---|
| Inv. | TD521-4 | 28 | 0.03 | 6 | 0.2 |
| Inv. | SV287-1 | 31.8 | 0.04 | 0.5 | 0.3 |
| Inv. | SV302mod-2 | 29.4 | 0.05 | 7 | 2 |
| Inv. | SV292-6 | 28.6 | 0.5 | 4.5 | 0.3 |
| Inv. | SV298-6 | 28.05 | 0.95 | 6 | 0.2 |
| Inv. | 15 | 33.78 | 1.02 | 0.13 | 0.18 |
| Inv. | SV304-1 | 30 | 2 | 7 | 0.1 |
| Inv. | SV313-6 | 29.3 | 1.89 | 6 | 0.2 |
| Inv. | SV326-6 | 28.4 | 1.88 | 6 | 0.2 |
| Inv. | TD561-4 | 29 | 2 | 10 | 0.3 |
| Inv. | SV302mod-1 | 30 | 0.05 | 7 | 0.2 |
| Inv. | SV315-3 | 32.5 | 1.97 | 2 | 0.2 |
| Inv. | SV317-3 | 34.5 | 1.97 | 2 | 0.2 |
| Inv. | SV314-6 | 30.3 | 1.89 | 6 | 0.2 |
| Inv. | SV317-6 | 33.1 | 1.89 | 6 | 0.2 |
| Inv. | TD561-5 | 30 | 2 | 10 | 0.3 |
| Comp. | SV301mod-1 | 30 | 0.05 | 0.15 | 0.2 |
| Comp. | SV292-1 | 29.9 | 0.5 | 0.12 | 0.3 |
| Comp. | TC768 | 30 | 2 | 3 | 0.3 |

A series of tests was carried out in order to determine the saturation induction at 20° C., the Curie point, the coercive field at 20° C., the electrical resistivity at 20° C. and the acid corrosion resistance.

The results of these tests are given in Table 16.

TABLE 16
Results of the trials

| | | Bₛ^{20° C.} | T_{c} | H_{c} | ρₑₗ | I^{ox} |
|---|---|---|---|---|---|---|
| | Grade | (G) | (° C.) | (mOe) | (μΩ · cm) | (mA) |
| Inv. | TD521-4 | 8030 | 156 | 71 | 84.5 | 2.1 |
| Inv. | SV287-1 | 8420 | 152 | 41 | 83 | 4.5 |
| Inv. | SV302mod-2 | 7580 | 154 | 44 | 84 | 4.6 |
| Inv. | SV292-6 | 7530 | 154 | 70 | 87 | 3.9 |
| Inv. | SV298-6 | 7590 | 153 | 57 | 85.5 | 2.4 |
| Inv. | 15 | 8150 | 159 | 42.5 | 81 | 2.5 |
| Inv. | SV304-1 | 8530 | 163 | 48 | 85 | 0.85 |
| Inv. | SV313-6 | 8320 | 161 | 33 | 86.5 | 1.2 |
| Inv. | SV326-6 | 8490 | 168 | 55 | 86.5 | 2.9 |
| Inv. | TD561-4 | 8490 | 178 | 75 | 80.5 | 0.9 |
| Inv. | SV302mod-1 | 9820 | 199 | 75 | 85 | 4.5 |
| Inv. | SV315-3 | 9520 | 174 | 39 | 87 | 1.3 |
| Inv. | SV317-3 | 11360 | 205 | 38.5 | 85 | 1.3 |
| Inv. | SV314-6 | 9190 | 183 | 34 | 86 | 1.2 |
| Inv. | SV317-6 | 11470 | 229 | 36 | 84.5 | 1.2 |
| Inv. | TD561-5 | 9370 | 178 | 70 | 81 | 0.9 |
| Comp. | SV301mod-1 | 4300 | 86 | 23 | 81 | 4.5 |
| Comp. | SV292-1 | 4490 | 90 | 36 | 81.5 | 4.4 |
| Comp. | TC768 | 7380 | 118 | 41 | 88.6 | 1.3 |

It may be seen that all the alloys according to the invention have an electrical resistivity at 20° C. of at least 80 μΩ.cm and a coercive field of less than 75 mOe and in general less than 41 mOe, at 20° C. This performance combined with less thickness and good inter-turn insulation ensure low magnetic losses, this being all the more admissible in these magnetic cores of passive magnetic components as their good thermal conduction allows these magnetic losses to be easily dissipated.

It may be seen in counter-examples SV301mod-1, SV292-1 and TC768 that the balance between % Ni and % Cu must be correctly ensured so that the saturation is sufficient, i.e. so that the design of the magnetic circuit leads to a sufficiently useful volume with respect to ferrites.

### Example 9

### Bimetallic Strips

Several alloys were produced to a final thickness of 0.6 mm to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled down to a thickness of 0.6 mm, then annealed between 800 and 1100° C. for 1 h, then degreased, cut into various parts or washers for measurements and then annealed at 1100° C. for 3 h in purified H₂ (dew point <−70° C.).

The grades tested contained the elements mentioned in the following table, the balance being iron and the inevitable impurities.

TABLE 17
Composition of the grades for the trials

| | Grade | % Ni | % Cr | % Cu | % Mn |
|---|---|---|---|---|---|
| Inv. | SV285mod-3 | 32 | 0.04 | 2 | 0.3 |
| Inv. | SV285mod-5 | 32 | 0.04 | 4 | 0.3 |
| Inv. | SV287-5 | 31 | 0.04 | 3.7 | 0.2 |
| Inv. | SV316-6 | 32 | 1.89 | 6 | 0.2 |
| Inv. | TD561-6 | 31 | 2 | 10 | 0.3 |
| Inv. | TD561-8 | 33 | 2 | 10 | 0.3 |
| Comp. | Invar | 36 | 0 | 0 | 0.2 |
| Comp. | N42 | 42 | 0 | 0 | 0.2 |
| Comp. | SV285mod-1 | 32 | 0.04 | 0.53 | 0.3 |
| Comp. | SV285mod-7 | 32 | 0.04 | 0.01 | 0.3 |
| Comp. | SV287-1 | 32 | 0.04 | 0.5 | 0.2 |
| Comp. | TD521-1 | 28 | 0.03 | 0.12 | 0.2 |
| Comp. | TD521-4 | 28 | 0.03 | 6 | 0.2 |

A series of tests was carried out in order to determine the salt-fog corrosion resistance, the mechanical wear resistance, the Curie point, the electrical resistivity at 20° C., the expansion coefficient between 20 and 200° C. and the expansion coefficient between 20 and 300° C.

The results of these tests are given in Table 18.

TABLE 18
Results of the trials

| | | | | T_{c} | ρₑₗ | α₂₀₋₁₀₀ | α₂₀₋₃₀₀ |
|---|---|---|---|---|---|---|---|
| | Grade | SFC | MW | (° C.) | (μΩ · cm) | (10⁻⁶/° C.) | (10⁻⁶/° C.) |
| Inv. | SV285mod-3 | − | ++ | 211 | 85 | 3.1 | 8.7 |
| Inv. | SV285mod-5 | − | ++ | 229 | 85.8 | 2.7 | 6.9 |
| Inv. | SV287-5 | − | ++ | 198 | 86.5 | 4.1 | 9.4 |
| Inv. | SV316-6 | 0 | ++ | 211 | 85 | 4.8 | 8.3 |
| Inv. | TD561-6 | 0 | ++ | 204 | 80.1 | 5.1 | 8.5 |
| Inv. | TD561-8 | 0 | ++ | 247 | 78.7 | 5.6 | 7.4 |
| Comp. | Invar | −− | ++ | 250 | 75 | 1.5 | 6 |
| Comp. | N42 | −− | ++ | 330 | 63 | 4 | 4.3 |
| Comp. | SV285mod-1 | − | ++ | 205 | 84 | 4.2 | 10.1 |
| Comp. | SV285mod-7 | − | ++ | 185 | 83.5 | 4.9 | 10.7 |
| Comp. | SV287-1 | − | ++ | 152 | 83 | 5.3 | 10.9 |
| Comp. | TD521-1 | − | ++ | −10 | 82 | 16.8 | 18.5 |
| Comp. | TD521-4 | − | ++ | 156 | 84.5 | 9.6 | 11.9 |

### Example 10

### Watch Motor Coil Cores and High-Sensitivity Electromagnetic Relays

Several alloys were produced down to a final thickness of 0.6 mm so as to characterize the usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled without intermediate annealing from the hot-rolled thickness down to a thickness of 0.6 mm and then cut into various parts or washers for measurements, before being degreased and then annealed at 1100° C. for 3 hours in purified H₂ (dew point <−70° C.).

The grades tested contained the elements mentioned in the following table, the balance being iron and the inevitable impurities.

TABLE 19
Composition of the grades for the trials

| | Grade | % Ni | % Cr | % Cu | % Mn | % Si |
|---|---|---|---|---|---|---|
| Inv. | SV285-3 | 31.8 | 0.04 | 2 | 0.3 | 0.21 |
| Inv. | SV287-6 | 30.2 | 0.04 | 5.5 | 0.3 | 0.23 |
| Inv. | SV315-5 | 31.9 | 1.93 | 4 | 0.2 | 0.26 |
| Inv. | SV315-6 | 31.2 | 1.89 | 6 | 0.2 | 0.26 |
| Inv. | TD561-6 | 31 | 2 | 10 | 0.3 | 0.24 |
| Inv. | SV288-1 | 35.8 | 0.05 | 0.5 | 0.3 | 0.23 |
| Inv. | SV288-4 | 34.9 | 0.05 | 2.9 | 0.3 | 0.26 |
| Inv. | SV288-6 | 34 | 0.05 | 5.6 | 0.3 | 0.25 |
| Inv. | SV285mod-4 | 32.45 | 0.04 | 3 | 0.3 | 0.35 |
| Inv. | SV285mod-6 | 32.45 | 0.04 | 6 | 0.3 | 0.38 |
| Inv. | SV316-3 | 33.5 | 1.97 | 2 | 0.2 | 0.33 |
| Inv. | SV316-5 | 33.2 | 1.93 | 4 | 0.2 | 0.37 |
| Inv. | SV317-2 | 34.8 | 1.99 | 1 | 0.2 | 0.35 |
| Inv. | SV317-4 | 34.1 | 1.95 | 3 | 0.2 | 0.36 |
| Inv. | SV316-6 | 32.2 | 1.89 | 6 | 0.2 | 0.35 |
| Inv. | TD561-8 | 33 | 2 | 10 | 0.3 | 0.34 |
| Inv. | SV288-5 | 34.6 | 0.05 | 3.8 | 0.21 | 0.23 |
| Inv. | SV288-6 | 34 | 0.05 | 5.6 | 0.23 | 0.43 |
| Inv. | SV560-6 | 33 | 0.1 | 10 | 0.2 | 0.35 |
| Inv. | SV560-9 | 35.95 | 0.05 | 10 | 0.2 | 0.19 |
| Inv. | SV316-1 | 34 | 2 | 0.5 | 0.2 | 0.32 |
| Comp. | TC661 | 33.8 | 5 | 2 | 0.15 | 0.22 |

A series of tests was carried out in order to determine the salt-fog corrosion resistance, the mechanical wear resistance, the electrical resistivity at 20° C., the Curie point, the saturation induction at 20° C., the coercive field at 20° C. and the acid corrosion resistance.

The results of these tests are given in Table 20.

It may be seen that it is possible to obtain a saturation at 20° C. of 10000 G with only 30% Ni, and a saturation of 13000 G at 20° C. with only 34% Ni.

This performance is very advantageous and innovative, apart from the good corrosion resistance and mechanical wear resistance properties of the oxidized layer.

TABLE 20
Results of the trials

| | | | | r_{elec} | T_{c} | Bₛ^{20° C.} | H_{c} | I^{ox} |
|---|---|---|---|---|---|---|---|---|
| | Grade | SFC | MW | (μΩ · cm) | (° C.) | (G) | (mOe) | (mA) |
| Inv. | SV285-3 | − | ++ | 85 | 198 | 10050 | 53 | 4.4 |
| Inv. | SV287-6 | − | ++ | 84.5 | 202 | 10010 | 72 | 3.95 |
| Inv. | SV315-5 | 0 | ++ | 88 | 189 | 10020 | 42 | 1.1 |
| Inv. | SV315-6 | 0 | ++ | 85.5 | 197 | 10050 | 43 | 1.2 |
| Inv. | TD561-6 | 0 | ++ | 80 | 204 | 10090 | 65 | 0.8 |
| Inv. | SV288-1 | − | ++ | 65 | NCO | 13230 | 88 | 4.1 |
| Inv. | SV288-4 | − | ++ | 75 | NCO | 13430 | 71 | 3.3 |
| Inv. | SV288-6 | − | ++ | 79 | NCO | 13430 | 67 | 3.7 |
| Inv. | SV285mod-4 | − | ++ | 86.5 | 218 | 12030 | 74 | 4.03 |
| Inv. | SV285mod-6 | − | ++ | 83 | 238 | 12410 | 91 | 3.9 |
| Inv. | SV316-3 | − | ++ | 83 | 198 | 10460 | 37 | 1.3 |
| Inv. | SV316-5 | 0 | ++ | 88 | 201 | 10790 | 40 | 1.1 |
| Inv. | SV317-2 | 0 | ++ | 76 | 204 | 11140 | 35.5 | 1.5 |
| Inv. | SV317-4 | 0 | ++ | 84 | 205 | 11460 | 36.5 | 1.3 |
| Inv. | SV316-6 | 0 | ++ | 85 | 211 | 10810 | 38 | 1.2 |
| Inv. | TD561-8 | 0 | ++ | 78 | 247 | 11350 | 56 | 0.8 |
| Inv. | SV288-5 | − | ++ | 72 | NCO | 13420 | 72 | 3.2 |
| Inv. | SV288-6 | − | ++ | 73 | NCO | 13430 | 67 | 2.9 |
| Inv. | SV560-6 | − | ++ | 70.5 | NCO | 13100 | 59 | 3.3 |
| Inv. | SV560-9 | − | ++ | 60.1 | NCO | 14070 | 77 | 1.6 |
| Inv. | SV316-1 | − | ++ | 83 | 191 | 10060 | 41 | 1.5 |
| Comp. | TC661 | 0 | ++ | 88 | 174 | 9000 | 49 | 0.5 |

### Example 11

### Devices for Contactless Temperature Measurement and Temperature-Violation Indication

Several alloys were produced down to a final thickness of 0.6 mm so as to characterize the usage properties. The alloys were produced from 99.9% pure materials, melted in a vacuum reduction furnace and cast into a 50 kg ingot. The ingot was forged between 1100 and 1300° C., then hot-rolled between 1000 and 1200° C. down to a thickness of 2.5 mm and then chemically pickled. The strip was then cold-rolled from the hot-rolled thickness down to a thickness of 0.6 mm, then annealed between 800 and 1100° C. for one hour, then degreased and cut into various parts or washers for measurements (see above for the various types of characterization used) and then annealed at 1100° C. for 3 hours in purified H₂ (dew point <−70° C.).

The grades tested contained the elements mentioned in the following table, the balance being iron and the inevitable impurities.

TABLE 21
Composition of the grades for the trials

| | Grade | % Ni | % Cr | % Cu | % Mn | % Si |
|---|---|---|---|---|---|---|
| Inv. | AA | 26.33 | 4 | 0.12 | 0.2 | 0.17 |
| Inv. | AB | 26.5 | 6 | 0.15 | 0.2 | 0.18 |
| Inv. | SV297-1 | 26.9 | 1.9 | 1 | 0.2 | 0.34 |
| Inv. | SV289-1 | 27.9 | 2 | 0.97 | 0.3 | 0.16 |
| Inv. | SV300-2 | 27.9 | 4 | 1 | 0.2 | 0.31 |
| Inv. | SV300-1 | 28 | 4 | 0.5 | 0.2 | 0.23 |
| Inv. | SV305-1 | 28 | 6 | 0.5 | 0.2 | 0.18 |
| Inv. | AC | 28 | 0.03 | 0.12 | 0.2 | 0.21 |
| Inv. | SV306-3 | 28.7 | 3.9 | 2 | 0.2 | 0.16 |
| Inv. | AD | 29 | 0.03 | 0.15 | 0.2 | 0.31 |
| Inv. | SV287-1 | 31.8 | 0.04 | 0.5 | 0.3 | 0.17 |
| Inv. | SV323-5 | 32 | 1.92 | 0.6 | 3.84 | 0.18 |
| Inv. | SV285mod-3 | 32.45 | 0.04 | 2 | 0.3 | 0.15 |
| Comp. | AE | 27 | 0.03 | 0.14 | 0.2 | 0.23 |

A series of tests was carried out in order to determine the salt-fog corrosion resistance, the mechanical wear resistance, the saturation induction at 20° C., the Curie point, the coercive field at 20° C. and the acid corrosion resistance.

The results of these tests are given in Table 22.

TABLE 22
Results of the trials

| | | | | Bₛ^{20° C.} | T_{c} | H_{c} | I^{ox} |
|---|---|---|---|---|---|---|---|
| | Grade | SFC | MW | (G) | (° C.) | (mOe) | (mA) |
| Inv. | AA | − | ++ | 0 | −50 | NCO | 3.7 |
| Inv. | AB | − | ++ | 0 | −50 | NCO | 3.1 |
| Inv. | SV297-1 | − | ++ | 1530 | 24 | 21.3 | 2.6 |
| Inv. | SV289-1 | − | ++ | 2540 | 43 | NCO | NCO |
| Inv. | SV300-2 | − | ++ | 1970 | 37 | 27.5 | 1.9 |
| Inv. | SV300-1 | − | ++ | 1570 | 24 | 18.8 | 1.7 |
| Inv. | SV305-1 | − | ++ | 1140 | 18 | 13.8 | 1.4 |
| Inv. | AC | − | ++ | 0 | −10 | NCO | 4.7 |
| Inv. | SV306-3 | − | ++ | 3840 | 70 | NCO | NCO |
| Inv. | AD | − | ++ | 1650 | 25 | 17.5 | 4.5 |
| Inv. | SV287-1 | − | ++ | 8420 | 152 | NCO | NCO |
| Inv. | SV323-5 | − | ++ | 3620 | 56 | NCO | NCO |
| Inv. | SV285mod-3 | − | ++ | 11060 | 211 | NCO | NCO |
| Comp. | AE | − | ++ | 3700 | −50 | 350 | 4.9 |

It should be noted that the counter-example does not satisfy equation 1, which means that the alloy is not fully austenitic. The non-austenitic character of the alloy prevents the required coercive field values being achieved.

### Example 12

### Hypertextured Substrates for Epitaxy

Several alloys were produced down to a final thickness of 0.1 mm so as to characterize their usage properties. The alloys were produced from 99.9% pure materials, melted in a vacuum induction furnace and cast into a 50 kg ingot. The ingot was forged between 1100 and 1300° C., then hot-rolled between 1000 and 1200° C. down to a thickness of 5 mm, and then chemically pickled. The strip was then cold-rolled down to a thickness of 0.1 mm without intermediate annealing and then mechanically polished with an abrasive polishing felt to a very fine polishing grit of the order of one micron. The metal was then annealed between 800 and 1100° C. for one hour and then cut into various parts for measuring X-ray pole figures in order to evaluate the type and intensity of the texture obtained.

The grades tested contained the elements mentioned in the following table, the balance being iron and the inevitable impurities.

TABLE 23
Composition of the grades for the trials

| | Grade | % Ni | % Cr | % Cu | % Mn | % Si | % S + Se + Sb | % Ti + Al |
|---|---|---|---|---|---|---|---|---|
| Inv. | TC659 | 33.5 | 4.9 | 0.15 | 0.13 | 0.025 | 5 | 13 ppm |
| Inv. | TD544-4 | 31 | 0.5 | 3 | 0.23 | 0.21 | 7 | 11 ppm |
| Comp. | Fe—50%Ni | 48 | 0.06 | 0.03 | 0.35 | 0.03 | 23 | 15 ppm |

A series of tests was carried out in order to determine the salt-fog corrosion resistance, the mechanical wear resistance, the Curie point, the acid corrosion resistance, the expansion coefficient between 20 and 300° C., the twinning content and the average texture misorientation angle.

The results of these tests are given in Table 24.

TABLE 24
Results of the trials

| | | Deformation | | | T_{c} | Iₒₓ^{max} | α_{20-300° C.} | Twinning | |
|---|---|---|---|---|---|---|---|---|---|
| | Grade | ratio (%) | SFC | MW | (° C.) | (mA) | (10⁻⁶/° C.) | content (%) | ω(°) |
| Inv. | TC659 | 98 | 0 | ++ | 149 | 1.5 | 16.5 | 5 | 8 |
| Inv. | TD544-4 | 92 | 0 | ++ | 175 | 3.6 | 9.8 | 8 | 9 |
| Comp. | Fe—Ni 50 | 96 | − | ++ | 450 | 4.2 | 9 | 3 | 7 |

It may be seen that the alloys according to the invention have a strong capability of forming a {100}<001> cubic texture with a low twinning content (<10%) and a low average texture misorientation angle ω (<10° and a high mechanical wear resistance of the oxidized layer in a degraded operating atmosphere or annealing atmosphere thanks to the addition of minimal amounts of Cr, Si and Cu, and expansion coefficients that can vary over a wide range, making it possible to meet most of the expansion requirements for coatings on a substrate for epitaxy.

1. Austenitic iron-nickel-chromium-copper alloy, the composition of which comprises in % by weight:
24%≦Ni≦36%
Cr≧0.02%
Cu≧0.1%
Cu+Co≦15%
0.01≦Mn≦6%
0.02≦Si≦2%
0≦Al+Ti≦3%
0≦C≦2%
0≦V+W≦6%
0≦Nb+Zr≦0.5%
0≦Mo≦8
Sn≦1
0≦B≦0.006%
0≦S+Se+Sb≦0.008%
0≦Ca+Mg≦0.020%
the balance being iron and impurities resulting from the smelting, the percentage nickel, chromium, copper and cobalt contents being such that the alloy furthermore satisfies the following conditions:
Co<Cu
Co<4% if Cr>7.5%
Eq1>28% with Eq1=Ni+1.2Cr+(Cu/5)
Cr<7.5% if Ni>32.5%,
and the manganese content furthermore meeting the following conditions:
$$\begin{matrix}if Eq 3 \geq 205 , & Mn \leq Ni - 27.5 + Cu - Cr \\ if 180.5 \leq Eq 3 \leq 205 , & Mn \leq 4 \% \\ if Eq 3 \leq 180.5 , & Mn \leq 2 \%\end{matrix}$$
$$with Eq 3 = 6 Ni - 2.5 X + 4 ( Cu + Co )$$
$$and X = Cr + Mo + V + W + Si + Al .$$

2. Alloy according to claim 1, characterized in that the percentage nickel, chromium, copper, cobalt, molybdenum, manganese, vanadium, tungsten, silicon and aluminium contents are such that the alloy furthermore satisfies the following conditions:
$$\begin{matrix}0.02 \leq Mn & \\ Eq 2 \geq 0.95 with & Eq 2 = ( Ni - 24 ) [ 0.18 + 0.08 ( Cu + Co ) ] \\ Eq 3 \geq 161 & \\ Eq 4 \leq 10 with & Eq 4 = Cr - 1.125 ( Cu + Co ) \\ Eq 5 \leq 13.6 with & Eq 5 = Cr - 0.227 ( Cu + Co ) \\ Eq 6 \geq 150 with & Eq 6 = 6 Ni - 2.5 X + 1.3 ( Co + Cu ) \\ Eq 7 \geq 160 with & Eq 7 = 6 Ni - 5 Cr + 4 Cu .\end{matrix}$$

3. Use of an alloy according to claim 2 for the manufacture of electromagnetic devices with temperature self-regulation.

4. Electromagnetic device with temperature self-regulation comprising an alloy according to claim 2.

5. Alloy according to claim 1, further characterized in that:
$$\begin{matrix}Ni \leq 29 \% & \\ Co \leq 2 \% & \\ 0.02 \leq Mn \leq 2 \% & \\ Eq 2 \geq 0.95 with & Eq 2 = ( Ni - 24 ) [ 0.18 + 0.08 ( Cu + Co ) ] \\ Eq 3 \geq 161 & \\ Eq 4 \leq 10 with & Eq 4 = Cr - 1.125 ( Cu + Co ) \\ Eq 5 \leq 13.6 with & Eq 5 = Cr - 0.227 ( Cu + Co ) \\ Eq 6 \geq 150 with & Eq 6 = 6 Ni - 2.5 X + 1.3 ( Co + Cu ) \\ Eq 7 \geq 160 with & Eq 7 = 6 Ni - 5 Cr + 4 Cu .\end{matrix}$$

6. Use of an alloy according to claim 5 for the manufacture of devices with magnetic flux self-regulation.

7. Device with magnetic flux self-regulation comprising an alloy according to claim 5.

8. Alloy according to claim 2, further characterized in that:
Ni≦35%
C≦0.5%
Eq2≧1
Eq3≧170
Eq6≧159
Eq7≧160.

9. Use of an alloy according to claim 8 for the manufacture of controlled-expansion devices.

10. Controlled-expansion device comprising an alloy according to claim 8.

11. Alloy according to claim 2, further characterized in that:
Cu≦10%
C≦0.1
Eq2≧1
Eq3≧170
Eq6≧159
Eq7≧160.

12. Use of an alloy according to claim 11 for the manufacture of current sensors, measurement transformers or magneto-harmonic sensors.

13. Current sensor, measurement transformer or magneto-harmonic sensor comprising an alloy according to claim 11.

14. Alloy according to claim 2, further characterized in that:
0.05%≦Mn≦2%
C≦0.1
Eq2≧1.5
Eq3≧175
Eq4≦7 if Ni≦32.5
Eq5≦10.6 if Ni≦32.5
Eq6≧164
Eq7≧160

15. Use of an alloy according to claim 14 for the manufacture of motors and electromagnetic actuators.

16. Electromagnet actuator and motor comprising an alloy according to claim 14.

17. Alloy according to claim 14, furthermore characterized in that:
Co≦1.8%
O+N≦0.01%
the alloy furthermore satisfying at least one of the following relationships:
0.0002≦B≦0.002%
0.0008≦S+Se+Sb≦0.004%
0.001≦Ca+Mg≦0.015%.

18. Use of an alloy according to claim 17 for the manufacture of stators for clock or watch motors.

19. Stator for a clock or watch motor comprising an alloy according to claim 17.

20. Alloy according to claim 11, further characterized in that:
Eq2≧1.5%
Eq3≧189
Eq4≦4 if Ni≦32.5, or Eq4≦7 if Ni>32.5
Eq5≦4 if Ni≦32.5, or Eq5≦7 if Ni>32.5
Eq6≧173
Eq7≧185.

21. Use of an alloy according to claim 20 for the manufacture of inductors and transformers for power electronics.

22. Inductor or transformer for power electronics, comprising an alloy according to claim 20.

23. Alloy according to claim 2, further characterized in that:
Ni≧30%
C≦1%
Eq2≧1.5
Eq3≧189
Eq4≦4 if Ni≦32.5, or Eq4≦7 if Ni>32.5
Eq5≦4 if Ni≦32.5, or Eq5≦7 if Ni>32.5
Eq6≧173
Eq7≧185
Eq8≧33 with Eq8=Ni+Cu−1.5Cr.

24. Use of an alloy according to claim 23 for the manufacture of bimetallic strips.

25. Bimetallic strip comprising an alloy according to claim 23.

26. Alloy according to claim 14, further characterized in that:
Eq2≧2
Eq3≧195
Eq4≦2 if Ni≦32.5, or Eq4≦6 if Ni>32.5
Eq5≦2 if Ni≦32.5, or Eq5≦6 if Ni>32.5
Eq6≧180
Eq7≧190.

27. Alloy according to claim 26, further characterized in that:
Eq9≧13000 with Eq9=1100(Ni+Co/3+Cu/3)−1200Cr−26000

28. Use of an alloy according to either of claim 26 or 27 for the manufacture of the cores of clock or watch motor coils and electromagnetic relays of high sensitivity.

29. Core of a clock or watch motor coil or electromagnetic relay of high sensitivity comprising an alloy according to either of claim 26 or 27.

30. Alloy according to claim 1, further characterized in that:
$$\begin{matrix}Cu \leq 10 \% & \\ 0.02 \leq Mn & \\ C \leq 1 \% & \\ Eq 2 \geq 0.4 with & Eq 2 = ( Ni - 24 ) [ 0.18 + 0.08 ( Cu + Co ) ] \\ Eq 3 \geq 140 & \\ Eq 4 \leq 10 with & Eq 4 = Cr - 1.125 ( Cu + Co ) \\ Eq 5 \leq 13.6 with & Eq 5 = Cr - 0.227 ( Cu + Co ) \\ Eq 6 \geq 140 with & Eq 6 = 6 Ni - 2.5 X + 1.3 ( Co + Cu ) \\ Eq 7 \geq 125 with & Eq 7 = 6 Ni - 5 Cr + 4 Cu .\end{matrix}$$

31. Use of an alloy according to claim 30 for the manufacture of devices for contactless temperature measurement or temperature violation indication.

32. Contactless temperature measurement or temperature violation indication device comprising an alloy according to claim 30.

33. Alloy according to claim 1, further characterized in that:
Mn≦2%
Si≦1%
Cu≦10%
Cr+Mo≦18%
C≦0.1
Ti+Al≦0.5%,
the alloy furthermore satisfying at least one of the following relationships:
0.0003≦B≦0.004%
0.0003≦S+Se+Sb≦0.008%.

34. Alloy according to claim 33, further characterized in that:
0.003≦Nb+Zr≦0.5%.

35. Use of an alloy according to either of claim 33 or 34 for the manufacture of hyper-textured substrates for epitaxy.

36. Hyper-textured substrate for epitaxy comprising an alloy according to either of claim 33 or 34.
